(19) United States
(12) Patent Application Publication
(10) Pub. No.: US 2021/0130030 A1
(43) Pub. Date: May 6, 2021

(54) CONTAINER HAVING AN UNFOLDED CONTAINER LAYER, CONTAINING A PLURALITY OF PARTICLES, AND HAVING A POLYMER LAYER

(71) Applicant: SIG TECHNOLOGY AG, Neuhausen am Rheinfall (CH)

(72) Inventor: Werner Vierboom, Linnich (DE)

(21) Appl. No.: 16/639,630

(22) PCT Filed: Aug. 15, 2018
(86) PCT No.: PCT/EP2018/072151

§ 371 Date: Feb. 17, 2020

(30) Foreign Application Priority Data
Aug. 18, 2017 (DE) 10 2017 214 472.6

(51) Int. Cl. B65D 1/02; D21J 3/10; B32B 1/00; B32B 27/32

(52) U.S. Cl. CPC B65D 1/0215; D21J 3/10; B32B 1/00; B29K 2311/14; B29B 2911/14473; B29B 2911/14033; B29B 2911/1402; B32B 27/32

(57) ABSTRACT

The invention relates to a container comprising a container wall that partly surrounds a container interior, wherein the container wall
a) has a container opening;
b) comprises a container layer comprising
   i) a multitude of particles, and
   ii) no fold and no crease;
and
c) comprises a first polymer layer that at least partly superimposes the container layer;
   wherein the container interior
a. has a maximum diameter in a plane perpendicular to a height of the container interior, and
b. has a diameter less than the maximum diameter of the container interior at least in sections in the direction from the plane to the container opening.

The invention further relates to a method of superimposing a container precursor with a polymer composition; a container obtainable by that method; an apparatus for superimposing a container precursor with a polymer composition; a method of filling and closing one of the aforementioned containers and the closed container obtainable thereby; and uses of a filling machine, of one of the aforementioned containers, of a polymer composition, and of a powder coating system.

The present invention relates to a container comprising a container wall that partly surrounds a container interior, wherein the container wall
a) has a container opening;
b) comprises a container layer comprising
   i) a multitude of particles, and
   ii) no fold and no crease;
and
c) comprises a first polymer layer that at least partly superimposes the container layer;
   wherein the container interior
a. has a maximum diameter in a plane perpendicular to a height of the container interior, and
b. has a diameter less than the maximum diameter of the container interior at least in sections in the direction from the plane to the container opening.
   The invention further relates to a method of superimposing a container precursor with a polymer composition; a container obtainable by that method; an apparatus for superimposing a container precursor with a polymer composition; a method of filling and closing one of the aforementioned containers and the closed container obtainable thereby; and uses of a filling machine, of one of the aforementioned containers, of a polymer composition, and of a powder coating system.

The prior art discloses various containers for the dispensing, transporting and storing of free-flowing food or drink products, whether they be food or drink products for human consumption or else animal nutrition products. Typical demands on these containers are a low intrinsic weight for transport; maximum variety of shape in container production; suitability for storage with maximum saving of space; mechanical stability, especially in the stacking and the emptying of the containers; leaktightness; openability; and pouring characteristics. A further demand which is gaining increasing significance is environmental compatibility. This in turn is an umbrella term for numerous aspects, for example consumption of raw materials and energy in the container production, the use of a maximum proportion of renewable raw materials, suitability for recycling, and tolerability in respect of health. Illustrative free-flowing food or drink products are beverages. There follows a brief discussion of typical beverage containers known in the prior art.

Containers that have long been known for beverages are bottles, especially glass bottles. Glass bottles, because of their essentially cylindrical shape, have the disadvantage that very dense and space-saving storage is barely possible. At the same time, glass bottles are limited to this shape by virtue of their manufacturing method. Although other shapes are obtainable specifically from glass, these require some additional complexity in manufacture and often lead to glass bottles that are disadvantageous in other ways, for example less stable. Glass bottles fundamentally have a considerable disadvantage here by virtue of their fragility, which additionally involves a risk of injury. For that reason, glass bottles are banned at many public events. Moreover, glass bottles have considerable intrinsic weight, which leads to increased energy expenditure in transport. In addition, production of glass, even when the glass used for the purpose has been recycled, necessitates quite a high expenditure of energy. An additional aggravating factor is elevated expenditure on transport. Glass bottles are usually prefabricated in a glass factory and then have to be transported to the facility where the beverage is dispensed with the use of considerable transport volumes.

Other prior art bottles are manufactured from plastic. These plastic bottles have some improvements with regard to the above disadvantages. However, plastic bottles having low intrinsic weight often have limited mechanical stability. It is thus not uncommon for plastic bottles to contract in the course of pouring, and hence for some of the contents to be spilled. Attempts are made in the prior art to reduce this problem, for example by means of appropriate corrugations in the bottle wall. However, this is often successful only to a limited degree. If plastic bottles, by contrast, are to be more dimensionally stable, their wall has to be made correspondingly thick, which considerably increases the intrinsic weight of the bottles and raw material consumption. The latter is particularly disadvantageous for plastic bottles since these are usually manufactured from non-renewable raw materials in large portions. The obtaining of the plastic usually entails intensive petrochemical processes, and recycling is comparatively complex. Biodegradation of the plastic is barely possible to date. Plastic bottles are not very environmentally friendly for various reasons.

A further development known in the prior art in the field of containers for beverages is that of film bags. These containers made of an often multilayer composite film have zero dimensional stability, which leads to considerable disadvantages. In the course of storage and transport, the bags can easily be damaged, which makes them leaky. Moreover, opening aids have to be provided by the manufacturer for opening of the bags, or it is necessary to use tools, for example scissors, for opening. A considerable problem for the end user that arises when using the film bags is the pouring characteristics. The lack of dimensional stability often results in spillage of container contents. Moreover, the opened bags are difficult to store. For the milk bags that used to be widespread, an attempt was made here to provide a remedy with special milk bag holders, a solution that was obviously not very satisfactory. Thus, this additional holding apparatus must be fitted exactly to the size of the milk bag. If the milk bag has been emptied to a certain degree, the holder no longer fits and is no longer suitable for pouring. The disadvantages of the film bags are so considerable that milk bags, for example, are barely still encountered on the market.

The disadvantages of dimensionally unstable containers are avoided by containers manufactured from foldable composites, called laminates. These laminates, as well as a multitude of polymer layers, typically comprise a cardboard layer that imparts dimensional stability thereto. Moreover, these laminates typically have a barrier layer that increases impermeability. This layer is often manufactured from aluminum. The containers are typically manufactured by folding the laminate and sealing particular laminate regions. By virtue of this mode of production, the variety of shapes of these containers is limited. For instance, the laminates cannot be folded to an unlimited degree without losing their tightness. Moreover, round containers, for example bottles, can typically be produced only with difficulty from these laminates, for example through the use of additional container components such as a separate container base made of plastic. Moreover, opening aids or additional tools are required for opening of these containers as well. Since the laminates used are typically foldable but have a certain flexibility, the laminate containers are essentially dimensionally stable, but not as stiff and rigid as glass bottles, for example. This leads to disadvantages in stackability and also on pouring. As already set out, the laminates typically consist of a number of mutually joined layers comprising different polymers and often also aluminum. Such multilayer constructions entail some complexity in recycling. In the prior art, the drive to improve the laminate containers led to ever more complex layer constructions with numerous different materials and material mixtures. The multitude of polymers used is considered to be disadvantageous here, for environmental reasons for example.

In the light of the urgent need for a very environmentally friendly dimensionally stable food or drink product container having maximum freedom in the choice of shape, the containers of the invention open up a new category of containers. Rather than further developing the highly modern and increasingly complex laminate containers, the inventors have concentrated on an environmentally friendly starting material that has not been considered to date for manufacture of containers, especially bottles, for free-flowing food or drink products. Thus, this material obtained from wood via pulp has been used to date merely for egg cartons, i.e. for non-free-flowing food or drink products. The fact that this environmentally friendly material made from renewable raw materials has already long been known for egg cartons and has not be considered to date for development for the use of the invention shows that a completely new strand of development has been opened up here, overcoming established technical prejudices.

In general terms, it is an object of the present invention to at least partly overcome a disadvantage that arises from the prior art. It is a further object of the invention to provide a bottle which is as environmentally friendly as possible for free-flowing food or drink products. The bottle here preferably consists to a maximum possible degree of renewable raw materials. Moreover, the bottle is preferably very easily recyclable.

It is a further object of the invention to provide a bottle which is as environmentally friendly as possible and has good stackability, preferably without additional secondary packaging, for free-flowing food or drink products. For this purpose, the bottle of the invention preferably has maximum mechanical stability, especially to compression. Moreover, this bottle, when the contents of the bottle are poured out, maintains its shape even when pressure is exerted on the bottle wall. It is a further object of the invention to provide the aforementioned mechanically stable bottle, wherein the bottle very substantially retains its mechanical stability, especially in its mouth region, even after opening and repeated pouring of liquid out of the bottle with intermediate storage of the bottle, especially in a cooling device such as a refrigerator. It is a further object of the invention to provide a bottle which is as environmentally friendly as possible for free-flowing food or drink products that features improved tactile properties when drinking directly from the bottle. It is yet a further object of the invention to provide a bottle which is as environmentally friendly as possible for free-flowing food or drink products which is very hygienic, especially when drinking directly from the bottle. It is yet a further object of the invention to provide a bottle which is as environmentally friendly as possible for free-flowing food or drink products and which is suitable for provision with a printed decoration of maximum quality on its outside.

It is a further object of the invention to provide a bottle for free-flowing food or drink products that can be manufactured in a very wide variety of different shapes. In addition, it is an object of the invention to provide a bottle for free-flowing food or drink products of very simple construction. It is a basic requirement of a bottle for free-flowing food or drink products that it has a minimum degree of watertightness. It is an object of the invention to achieve this watertightness over a maximum possible area and at the same time preferably to minimize the intrinsic weight of the bottle. More particularly, the bottle here should preferably be as environmentally friendly as possible, preferably through the use of a minimum level of chemical additives in the bottle production.

It is a further object of the invention to provide a bottle for free-flowing food or drink products that has one or more of the aforementioned advantages and additionally has minimum intrinsic weight. The intrinsic weight may especially be achieved here through use of a minimum amount of material or by means of a bottle wall with a minimum number of layers, especially without an additional primer layer. It is a further object of the invention to provide a bottle for free-flowing food or drink products that has one or more of the aforementioned advantages and additionally has minimum discoloration of any wall of the bottle. It is a further object of the invention to provide a bottle for free-flowing food or drink products that has one or more of the aforementioned advantages, with a wall of the bottle additionally having maximum odor neutrality.

It is a further object of the invention to provide a method of producing a bottle which is as environmentally friendly as possible for free-flowing food or drink products that enables production of the bottle with minimum intrinsic weight coupled with minimum complexity. It is a further object of the invention to provide a method of producing a bottle which is as environmentally friendly as possible for free-flowing food or drink products and is of maximum simplicity, especially via a minimum number of steps. For instance, it is preferable that the method does not include any additional steps for adjusting a moisture content of a container precursor, especially by moistening or drying steps.

A contribution to the at least partial achievement of at least one, preferably more than one, of the above objects is made by the independent claims. The dependent claims provide preferred embodiments which contribute to the at least partial achievement of at least one of the objects.

A contribution to the achievement of at least one of the objects of the invention is made by an embodiment 1 of a container 1 comprising a container wall partly surrounding a container interior, wherein the container wall
a) has a container opening;
b) comprises a container layer comprising
   i) a multitude of particles, and
   ii) no fold and no crease;
and
c) comprises a first polymer layer that at least partly superimposes the container layer;
   wherein the container interior
a. has a maximum diameter in a plane perpendicular to a height of the container interior, and
b. has a diameter less than the maximum diameter of the container interior at least in sections in the direction from the plane to the container opening.
   The height of the container interior is preferably a greatest extent of the container interior in any Cartesian spatial direction. Further preferably, the height of the container interior extends from the container opening to a section of the container wall opposite the container opening, which is preferably a base of the container.

In one embodiment 2 of the invention, the container 1 is configured according to embodiment 1, wherein the particles of the multitude of particles are fibers.

In one embodiment 3 of the invention, the container 1 is configured according to embodiment 2, wherein the fibers are plant fibers.

In one embodiment 4 of the invention, the container 1 is configured according to embodiment 2 or 3, wherein the fibers comprise, preferably consist of, a chemical pulp or a mechanical pulp or both.

In one embodiment 5 of the invention, the container 1 is configured according to any of its preceding embodiments, wherein the container layer comprises solids in a proportion within a range from 50% to 99.9% by weight, more preferably from 60% to 99% by weight, more preferably from 70% to 99% by weight, more preferably from 75% to 99% by weight, more preferably from 80% to 99% by weight, more preferably from 85% to 99% by weight, even more preferably from 90% to 97% by weight, most preferably from 91% to 95% by weight, based in each case on the weight of the container layer. The solids preferably comprise the particles of the multitude of particles or are the particles of the multitude of particles.

In one embodiment 6 of the invention, the container 1 is configured according to any of its preceding embodiments, wherein the first polymer layer at least partly superimposes the container layer on a side remote from the container interior. In this connection, the first polymer layer is also referred to herein as outer polymer layer. In a preferred configuration of the container of the invention, the container comprises the outer polymer layer in a proportion of less than a value within a range from 2% to 15% by weight, preferably from 3% to 12% by weight, more preferably from 4% to 8% by weight, based in each case on the total weight of the container. Additionally or alternatively, the container layer is preferably superimposed by the outer polymer layer, in each case on its surface remote from the container interior, to an extent of 1% to 100%, more preferably to an extent of 1% to 90%, more preferably to an extent of 1% to 80%, more preferably to an extent of 1% to 70%, more preferably to an extent of 1% to 60%, more preferably to an extent of 1% to 50%, even more preferably to an extent of 1% to 40%, to an extent of more preferably from 1% to 30%, to an extent of more preferably from 3% to 20%, most preferably to an extent of 5% to 15%. Additionally or alternatively, the container wall comprises a mouth region that forms the container opening, wherein the container layer is superimposed by the outer polymer layer at least over the entire mouth region.

In one embodiment 7 of the invention, the container 1 is configured according to its embodiment 6, wherein the container wall additionally comprises a further polymer layer that at least partly superimposes the container layer on a side facing the container interior. In this connection, the further polymer layer is also referred to herein as inner polymer layer. In a preferred configuration of the container of the invention, the container comprises the inner polymer layer in a proportion within a range from 5% to 45% by weight, preferably from 5% to 40% by weight, more preferably from 5% to 35% by weight, even more preferably from 5% to 30% by weight, most preferably from 10% to 25% by weight, based in each case on the total weight of the container. Additionally or alternatively, the container layer is preferably superimposed by the inner polymer layer, in each case on its surface facing the container interior, to an extent of 50% to 100%, more preferably to an extent of 60% to 100%, more preferably to an extent of 70% to 100%, more preferably to an extent of 80% to 100%, even more preferably to an extent of 90% to 100%, most preferably to an extent of 95% to 100%.

In one embodiment 8 of the invention, the container 1 is configured according to any of its embodiments 1 to 5, wherein the first polymer layer at least partly superimposes the container layer on a side facing the container interior. In this connection, the first polymer layer is also referred to herein as inner polymer layer. In a preferred configuration of the container of the invention, the container comprises the inner polymer layer in a proportion within a range from 5% to 45% by weight, preferably from 5% to 40% by weight, more preferably from 5% to 35% by weight, even more preferably from 5% to 30% by weight, most preferably from 10% to 25% by weight, based in each case on the total weight of the container. Additionally or alternatively, the container layer is preferably superimposed by the inner polymer layer, in each case on its surface facing the container interior, to an extent of 50% to 100%, more preferably to an extent of 60% to 100%, more preferably to an extent of 70% to 100%, more preferably to an extent of 80% to 100%, even more preferably to an extent of 90% to 100%, most preferably to an extent of 95% to 100%.

In one embodiment 9 of the invention, the container 1 is configured according to its embodiment 8, wherein the container wall additionally comprises a further polymer layer that at least partly superimposes the container layer on a side remote from the container interior. In this connection, the further polymer layer is also referred to herein as outer polymer layer. In a preferred configuration of the container of the invention, the container comprises the outer polymer layer in a proportion of less than a value within a range from 2% to 15% by weight, preferably from 3% to 12% by weight, more preferably from 4% to 8% by weight, based in each case on the total weight of the container. Additionally or alternatively, the container layer is preferably superimposed by the outer polymer layer, in each case on its surface remote from the container interior, to an extent of 1% to 100%, more preferably to an extent of 1% to 90%, more preferably to an extent of 1% to 80%, more preferably to an extent of 1% to 70%, more preferably to an extent of 1% to 60%, more preferably to an extent of 1% to 50%, even more preferably to an extent of 1% to 40%, to an extent of more preferably from 1% to 30%, to an extent of more preferably from 3% to 20%, most preferably to an extent of 5% to 15%. Additionally or alternatively, the container wall comprises a mouth region that forms the container opening, wherein the container layer is superimposed by the outer polymer layer at least over the entire mouth region on the side remote from the container interior.

In one embodiment 10 of the invention, the container 1 is configured according to any of its preceding embodiments, wherein the first polymer layer comprises a first polymer in a proportion within a range from 50% to 100% by weight, preferably from 60% to 100% by weight, more preferably from 70% to 100% by weight, more preferably from 80% to 100% by weight, most preferably from 90% to 100% by weight, based in each case on the weight of the first polymer layer.

In one embodiment 11 of the invention, the container 1 is configured according to its embodiment 10, wherein the first polymer is one selected from the group consisting of a polycondensate, a polyolefin, and a polyvinyl alcohol, or a combination of at least two of these.

In an embodiment 12 of the invention, the container 1 is configured according to any of its embodiments 7, or 9 to 11, wherein the further polymer layer comprises a further polymer in a proportion within a range from 50% to 100% by weight, preferably from 60% to 100% by weight, more preferably from 70% to 100% by weight, more preferably from 80% to 100% by weight, most preferably from 90% to 100% by weight, based in each case on the weight of the further polymer layer.

In one embodiment 13 of the invention, the container 1 is configured according to its embodiment 12, wherein the further polymer is one selected from the group consisting of a polycondensate, a polyolefin, and a polyvinyl alcohol, or a combination of at least two of these.

In one embodiment 14 of the invention, the container 1 is configured according to any of its preceding embodiments, wherein the first polymer layer or the further polymer layer or each of them has an average layer thickness within a range from 1 to 100 μm, preferably from 10 to 100 μm, more preferably from 20 to 100 μm.

In one embodiment 15 of the invention, the container 1 is configured according to any of its preceding embodiments, wherein the container layer has an average thickness within a range from 100 to 2000 μm, preferably from 150 to 1800 μm, more preferably from 200 to 1500 μm, even more preferably from 250 to 1300 μm, most preferably from 300 to 1000 μm.

In one embodiment 16 of the invention, the container 1 is configured according to any of its preceding embodiments, wherein the container layer is at no point thinner than 100 μm, preferably than 150 μm, more preferably than 200 μm, more preferably than 250 μm, more preferably than 300 μm, more preferably than 400 μm, even more preferably than 450 μm, most preferably than 500 μm. The lack of such thin parts of the container layer increases the mechanical stability of the container, especially against compression.

In one embodiment 17 of the invention, the container 1 is configured according to any of its preceding embodiments, wherein the container has a compressive strength within a range from 100 to 250 N, preferably from 150 to 250 N.

In one embodiment 18 of the invention, the container 1 is configured according to any of its preceding embodiments, wherein the container wall has a water vapor permeation rate within a range from 0.009 to 0.14 g of water per cm² of container wall and year, preferably from 0.026 to 0.12 g of water per cm² of container wall and year, more preferably from 0.043 to 0.11 g of water per cm² of container wall and year.

In one embodiment 19 of the invention, the container 1 is configured according to any of its preceding embodiments, wherein the container opening has been covered with a closure. The container here is accordingly preferably a closed container.

In one embodiment 20 of the invention, the container 1 is configured according to any of its preceding embodiments, wherein the container interior comprises a fluid.

In one embodiment 21 of the invention, the container 1 is configured according to any of its preceding embodiments, wherein the container layer additionally comprises a hydrophobizing agent or a flow agent or both. The hydrophobizing agent or the flow agent is, or both are, preferably in solid form. Further preferably, the hydrophobizing agent or the flow agent is, or both are, joined to the particles of the multitude of particles.

In one embodiment 22 of the invention, the container 1 is configured according to any of its preceding embodiments, wherein the container layer has an average density within a range from 0.4 to 2.0 g/cm³, preferably from 0.4 to 1.8 g/cm³, more preferably from 0.4 to 1.6 g/cm³, more preferably from 0.4 to 1.4 g/cm³, more preferably from 0.4 to 1.2 g/cm³, more preferably from 0.4 to 1.0 g/cm³, even more preferably from 0.5 to 0.9 g/cm³, most preferably from 0.6 to 0.8 g/cm³.

A contribution to the achievement of at least one of the objects of the invention is made by an embodiment 1 of a method 1 comprising, as method steps,
a) providing a container precursor comprising a container precursor wall partly surrounding a container precursor interior, wherein the container precursor wall
   I. has a container precursor opening, and
   II. comprises a container layer comprising a multitude of particles,
wherein the container precursor interior
   i. has a maximum diameter in a plane perpendicular to a height of the container precursor interior, and
   ii. has a diameter less than the maximum diameter of the container precursor interior at least in sections in the direction from the plane to the container precursor opening; and
b) at least partly superimposing the container layer with a first polymer composition.
   The height of the container precursor interior is preferably a greatest extent of the container precursor interior in any Cartesian spatial direction. Further preferably, the height of the container precursor interior extends from the container precursor opening to a section of the container precursor wall opposite the container precursor opening, which is preferably a base of the container precursor. Preferably, the container layer extends over the entire surface of the container precursor wall. The method of the invention is preferably performed with the apparatus of the invention. In addition, the method of the invention is preferably a method of producing a container, preferably the container 1 of the invention in any of its embodiments. The first polymer layer of the container 1 of the invention in any of its embodiments is preferably obtainable from the first polymer composition. A preferred at least partial superimposing of the container layer with the first polymer composition is an at least partial coating of the container layer with the first polymer composition.

In one embodiment 2 of the invention, the method 1 is configured according to its embodiment 1, wherein the container layer does not comprise any fold or any crease.

In one embodiment 3 of the invention, the method 1 is configured according to either of its embodiments 1 and 2, wherein the particles of the multitude of particles are fibers.

In one embodiment 4 of the invention, the method 1 is configured according to its embodiment 3, wherein the fibers are plant fibers.

In one embodiment 5 of the invention, the method 1 is configured according to its embodiment 3 or 4, wherein the fibers comprise, preferably consist of, a chemical pulp or a mechanical pulp or both.

In one embodiment 6 of the invention, the method 1 is configured according to any of its embodiments 1 to 5, wherein the container layer comprises solids in a proportion within a range from 50% to 99.9% by weight, more preferably from 60% to 99% by weight, more preferably from 70% to 99% by weight, more preferably from 75% to 99% by weight, more preferably from 80% to 99% by weight, more preferably from 85% to 99% by weight, even more preferably from 90% to 97% by weight, most preferably from 91% to 95% by weight, based in each case on the weight of the container layer. The solids preferably comprise the particles of the multitude of particles or are the particles of the multitude of particles.

In one embodiment 7 of the invention, the method 1 is configured according to any of its embodiments 1 to 6, wherein the container precursor is provided in method step a) with a minimal first moisture content of the container layer, wherein the container layer in method step b) has a further moisture content, wherein the minimal first moisture content differs from the further moisture content by not more than 10% by weight, preferably not more than 5% by weight, more preferably not more than 3% by weight, more preferably not more than 1% by weight, where the moisture contents are each based on the weight of the container layer. The minimal first moisture content here is minimal in that this value is a minimal value of the moisture content of the container layer in method step a). Typically, the producing of the container layer comprises a reducing of a moisture content of the container layer or of a precursor of the container layer. This reducing can be effected by increasing a pressure, for example by pressing, or a temperature or both, for example in the form of a hot pressing. In this operation, it is obvious to reduce the moisture content of the container layer to 0% by weight since this at first appears advantageous in the container precursor production. However, it has been found that too low a moisture content has an adverse effect in method step b). Remoisturizing of the container layer between method steps a) and b) has been found to be particularly disadvantageous, especially since, as a result, homogeneous superimposing with the polymer composition was possible in method step b) only with use of a greater amount of the polymer composition, if at all. However, the latter leads to an undesirably high empty weight of the container and elevated raw material consumption. It has thus been found that, surprisingly, in the production of the container precursor, the moisture content of the container layer must not fall below a minimal value greater than 0% by weight. By contrast, a very small minimal value of the moisture content is advantageous for the production of the container precursor in order to obtain a maximum uniformity of the container layer.

In one embodiment 8 of the invention, the method 1 is configured according to its embodiment 7, wherein the minimum first moisture content is less than the further moisture content by not more than 10% by weight, preferably not more than 5% by weight, more preferably not more than 3% by weight, more preferably not more than 1% by weight, based in each case on the weight of the container layer.

In one embodiment 9 of the invention, the method 1 is configured according to its embodiment 7 or 8, wherein the minimal first moisture content is within a range from 1% to 20% by weight, more preferably from 3% to 17% by weight, more preferably from 5% to 20% by weight, more preferably from 5% to 15% by weight, even more preferably from 5% to 12% by weight, most preferably from 5% to 9% by weight, based in each case on the weight of the container layer.

In one embodiment 10 of the invention, the method 1 is configured according to any of its embodiments 1 to 9, wherein the providing of the container precursor in method step a) comprises producing the container layer from a composition, wherein the composition comprises
a. the multitude of particles, and
b. a liquid.
   The composition is preferably fluid, i.e. free-flowing. A preferred fluid composition is a suspension. A particularly preferred composition is a pulp. Preferably, the composition comprises the liquid in a proportion within a range from 90% to 99.9% by weight, more preferably from 91% to 99.9% by weight, more preferably from 92% to 99.9% by weight, more preferably from 93% to 99.9% by weight, more preferably from 94% to 99.9% by weight, most preferably from 95% to 99.5% by weight, based in each case on the total weight of the composition. Preferably, the composition comprises the multitude of particles in a proportion within a range from 0.1% to 5.0% by weight, preferably from 0.1% to 4.5% by weight, more preferably from 0.1% to 4.0% by weight, more preferably from 0.1% to 3.5% by weight, more preferably from 0.1% to 3.0% by weight, more preferably from 0.1% to 2.5% by weight, more preferably from 0.1% to 2.0% by weight, more preferably from 0.3% to 2.0% by weight, more preferably from 0.3% to 2.0% by weight, more preferably from 0.3% to 1.8% by weight, more preferably from 0.3% to 1.6% by weight, more preferably from 0.5% to 1.6% by weight, more preferably from 0.5% to 1.4% by weight, most preferably from 0.5% to 1.2% by weight, based in each case on the total weight of the composition. Further preferably, the composition comprises solids and solids-forming additives collectively in a proportion within a range from 0.1% to 5.0% by weight, preferably from 0.1% to 4.5% by weight, more preferably from 0.1% to 4.0% by weight, more preferably from 0.1% to 3.5% by weight, more preferably from 0.1% to 3.0% by weight, more preferably from 0.1% to 2.5% by weight, more preferably from 0.1% to 2.0% by weight, more preferably from 0.3% to 2.0% by weight, more preferably from 0.3% to 2.0% by weight, more preferably from 0.3% to 1.8% by weight, more preferably from 0.3% to 1.6% by weight, more preferably from 0.5% to 1.6% by weight, more preferably from 0.5% to 1.4% by weight, most preferably from 0.5% to 1.2% by weight, based in each case on the total weight of the composition. The particles of the multitude of particles belong here to the solids. Solids-forming additives herein are those additions that are not in the solid state of matter in the composition, and are in solid form after the drying of the composition, especially in the blank wall obtained from the composition or in the container layer.

In one embodiment 11 of the invention, the method 1 is configured according to any of its embodiments 1 to 10, wherein the container layer in method step b) is at least partly superimposed with the first polymer composition at least on a side facing the container precursor interior. In this connection, in the method of the invention, the first polymer composition preferably affords at least one inner polymer layer. The inner polymer layer superimposes the container layer on the side facing the container interior or the container precursor interior or both. Preferably, the container layer in method step b) is superimposed with the first polymer composition to an extent of 50% to 100%, more preferably to an extent of 60% to 100%, more preferably to an extent of 70% to 100%, more preferably to an extent of 80% to 100%, even more preferably to an extent of 90% to 100%, most preferably to an extent of 95% to 100%, in each case of its surface facing the container precursor interior. Preferably, the first polymer composition which is superimposed to the container layer in method step b) has a proportion of the weight of the container obtainable from the container precursor by the method of the invention within a range from 5% to 45% by weight, preferably from 5% to 40% by weight, more preferably from 5% to 35% by weight, even more preferably from 5% to 30% by weight, most preferably from 10% to 25% by weight. A preferred at least partial superimposing of the container layer with the first polymer composition is an at least partial coating of the container layer with the first polymer composition. A preferred coating method is powder coating.

In one embodiment 12 of the invention, the method 1 is configured according to any of its embodiments 1 to 10, wherein the container layer in method step b) is at least partly superimposed with the first polymer composition at least on a side remote from the container precursor interior. In this connection, in the method of the invention, the first polymer composition preferably affords at least one outer polymer layer. The outer polymer layer superimposes the container layer on the side remote from the container interior or the container precursor interior or both. Preferably, the container layer in method step b) is superimposed with the first polymer composition to an extent of 1% to 100%, more preferably to an extent of 1% to 90%, more preferably to an extent of 1% to 80%, more preferably to an extent of 1% to 70%, more preferably to an extent of 1% to 60%, more preferably to an extent of 1% to 50%, even more preferably to an extent of 1% to 40%, to an extent of preferably from 1% to 30%, to an extent of preferably from 3% to 20%, most preferably to an extent of 5% to 15%, in each case of its surface remote from the container precursor interior. Preferably, the first polymer composition which is superimposed to the container layer in method step b) has a proportion of the weight of the container obtainable from the container precursor by the method of the invention within a range from 2% to 15% by weight, preferably from 3 to 12% by weight, more preferably from 4% to 8% by weight. A preferred at least partial superimposing of the container layer with the first polymer composition is an at least partial coating of the container layer with the first polymer composition. A preferred coating method is powder coating.

In one embodiment 13 of the invention, the method 1 is configured according to any of its embodiments 1 to 11, wherein the method further comprises at least partly superimposing the container layer with a further polymer composition on a side remote from the container precursor interior. In this connection, in the method of the invention, the further polymer composition preferably affords at least one outer polymer layer. The outer polymer layer superimposes the container layer on the side remote from the container interior or the container precursor interior or both. Preferably, the container layer is superimposed with the further polymer composition to an extent of 1% to 100%, more preferably to an extent of 1% to 90%, more preferably to an extent of 1% to 80%, more preferably to an extent of 1% to 70%, more preferably to an extent of 1% to 60%, more preferably to an extent of 1% to 50%, even more preferably to an extent of 1% to 40%, to an extent of preferably from 1% to 30%, to an extent of preferably from 3% to 20%, most preferably to an extent of 5% to 15%, in each case of its surface remote from the container precursor interior. Preferably, the aforementioned further polymer composition which is superimposed to the container layer has a proportion of the weight of the container obtainable from the container precursor by the method of the invention within a range from 2% to 15% by weight, preferably from 3 to 12% by weight, more preferably from 4% to 8% by weight. A preferred at least partial superimposing of the container layer with the further polymer composition is an at least partial coating of the container layer with the further polymer composition. A preferred coating method is powder coating.

In one embodiment 14 of the invention, the method 1 is configured according to any of its embodiments 1 to 10, or 12, wherein the method further comprises at least partly superimposing the container layer with a further polymer composition on a side facing the container precursor interior. In this connection, in the method of the invention, the further polymer composition preferably affords at least one inner polymer layer. The inner polymer layer superimposes the container layer on the side facing the container interior or the container precursor interior or both. Preferably, the container layer is superimposed with the further polymer composition to an extent of 50% to 100%, more preferably to an extent of 60% to 100%, more preferably to an extent of 70% to 100%, more preferably to an extent of 80% to 100%, even more preferably to an extent of 90% to 100%, most preferably to an extent of 95% to 100%, in each case of its surface facing the container precursor interior. Preferably, the aforementioned further polymer composition which is superimposed to the container layer has a proportion of the weight of the container obtainable from the container precursor by the method of the invention within a range from 5% to 45% by weight, preferably from 5% to 40% by weight, more preferably from 5% to 35% by weight, even more preferably from 5% to 30% by weight, most preferably from 10% to 25% by weight. A preferred at least partial superimposing of the container layer with the further polymer composition is an at least partial coating of the container layer with the further polymer composition. A preferred coating method is powder coating.

In one embodiment 15 of the invention, the method 1 is configured according to any of its embodiments 1 to 14, wherein the method further comprises forming a first polymer layer from the first polymer composition. The first polymer layer here is an outer polymer layer when the container layer has been superimposed by the first polymer composition on its side remote from the container precursor interior. Additionally or alternatively, the first polymer layer here is an inner polymer layer when the container layer has been superimposed by the first polymer composition on its side facing the container precursor interior.

In one embodiment 16 of the invention, the method 1 is configured according to any of its embodiments 13 to 15, wherein the method further comprises forming a further polymer layer from the further polymer composition. The further polymer layer here is an outer polymer layer when the container layer has been superimposed by the further polymer composition on its side remote from the container precursor interior. Additionally or alternatively, the further polymer layer here is an inner polymer layer when the container layer has been superimposed by the further polymer composition on its side facing the container precursor interior.

In one embodiment 17 of the invention, the method 1 is configured according to its embodiment 15 or 16, wherein the forming of the first polymer layer from the first polymer composition comprises increasing a temperature of the first polymer composition. In a preferred embodiment, the first polymer composition has a first melting temperature, wherein the forming of the first polymer layer from the first polymer composition comprises increasing a temperature of the first polymer composition to or above the first melting temperature. This is particularly preferred in the case that the first polymer composition comprises or consists of a first multitude of polymer particles. Alternatively, in this case, the first polymer layer can be formed from the first polymer composition preferably as a sintering operation. The superimposing here with the first polymer composition is preferably effected as a powder coating operation. In this connection, the forming of the first polymer layer from the first polymer composition is also referred to as heat treatment. In a further preferred embodiment, the forming of the first polymer layer from the first polymer composition comprises reducing a liquid content of the first polymer composition. This is particularly preferred in the case that the first polymer composition comprises or consists of a first polymer emulsion. In a preferred embodiment, the first polymer composition has a first melting temperature, wherein the forming of the first polymer layer from the first polymer composition comprises increasing a temperature of the first polymer composition to a temperature of not more than 15° C., preferably not more than 10° C., above the first melting temperature. In a further preferred configuration of the method, the forming of the first polymer layer from the first polymer composition comprises increasing a temperature of the first polymer composition to a temperature of not more than 200° C., preferably not more than 180° C.

In one embodiment 18 of the invention, the method 1 is configured according to its embodiment 16 or 17, wherein the forming of the further polymer layer from the further polymer composition comprises increasing a temperature of the further polymer composition. In a preferred embodiment, the further polymer composition has a further melting temperature, wherein the forming of the further polymer layer from the further polymer composition comprises increasing a temperature of the further polymer composition to or above the further melting temperature. This is particularly preferred in the case that the further polymer composition comprises or consists of a further multitude of polymer particles. Alternatively, in this case, the further polymer layer can be formed from the further polymer composition preferably as a sintering operation. In a further preferred embodiment, the forming of the further polymer layer from the further polymer composition comprises reducing a liquid content of the further polymer composition. This is particularly preferred in the case that the further polymer composition comprises or consists of a further polymer emulsion. In a preferred embodiment, the further polymer composition has a further melting temperature, wherein the forming of the further polymer layer from the further polymer composition comprises increasing a temperature of the further polymer composition to a temperature of not more than 15° C., preferably not more than 10° C., above the further melting temperature. In a further preferred configuration of the method, the forming of the further polymer layer from the further polymer composition comprises increasing a temperature of the further polymer composition to a temperature of not more than 200° C., preferably not more than 180° C.

In one embodiment 19 of the invention, the method 1 is configured according to any of its embodiments 1 to 18, wherein the first polymer composition comprises a first multitude of polymer particles. In the context of this embodiment, the first polymer composition is preferably a dispersion or a powder. In the case of the powder, the first polymer composition preferably consists of the first multitude of polymer particles. In addition, in the case of the powder, the superimposing with the first polymer composition in method step b) is preferably effected as a powder coating operation. In a preferred embodiment, the first polymer composition has a liquid content of less than 20% by weight, based on the weight of the first polymer composition.

In one embodiment 20 of the invention, the method 1 is configured according to its embodiment 19, wherein the first multitude of polymer particles has a first particle size distribution having a D₅₀ within a range from 10 to 100 μm, preferably from 10 to 90 μm, more preferably from 20 to 80 μm, even more preferably from 30 to 70 μm, most preferably from 40 to 60 μm.

In one embodiment 21 of the invention, the method 1 is configured according to any of its embodiments 1 to 18, wherein the first polymer composition comprises, preferably consists of, a first polymer emulsion.

In one embodiment 22 of the invention, the method 1 is configured according to any of its embodiments 1 to 21, wherein the first polymer composition comprises a first polymer in a proportion within a range from 50% to 100% by weight, preferably from 60% to 100% by weight, more preferably from 70% to 100% by weight, more preferably from 80% to 100% by weight, most preferably from 90% to 100% by weight, based in each case on the weight of the first polymer composition.

In one embodiment 23 of the invention, the method 1 is configured according to its embodiment 22, wherein the first polymer is one selected from the group consisting of a polycondensate, a polyolefin, and a polyvinyl alcohol, or a combination of at least two of these.

In one embodiment 24 of the invention, the method 1 is configured according to any of its embodiments 13 to 23, wherein the further polymer composition comprises a further multitude of polymer particles. In the context of this embodiment, the further polymer composition is preferably a dispersion or a powder. In the case of the powder, the further polymer composition preferably consists of the further multitude of polymer particles. In addition, in the case of the powder, the superimposing with the further polymer composition is preferably effected as a powder coating operation. In a preferred embodiment, the further polymer composition has a liquid content of less than 20% by weight, based on the weight of the further polymer composition.

In one embodiment 25 of the invention, the method 1 is configured according to its embodiment 24, wherein the further multitude of polymer particles has a further particle size distribution having a D₅₀ within a range from 10 to 100 μm, preferably from 10 to 90 μm, more preferably from 20 to 80 μm, even more preferably from 30 to 70 μm, most preferably from 40 to 60 μm.

In one embodiment 26 of the invention, the method 1 is configured according to any of its embodiments 13 to 23, wherein the further polymer composition comprises, preferably consists of, a further polymer emulsion.

In one embodiment 27 of the invention, the method 1 is configured according to any of its embodiments 13 to 26, wherein the further polymer composition comprises a further polymer in a proportion within a range from 50% to 100% by weight, preferably from 60% to 100% by weight, more preferably from 70% to 100% by weight, more preferably from 80% to 100% by weight, most preferably from 90% to 100% by weight, based in each case on the weight of the further polymer composition.

In one embodiment 28 of the invention, the method 1 is configured according to its embodiment 27, wherein the further polymer is one selected from the group consisting of a polycondensate, a polyolefin, and a polyvinyl alcohol, or a combination of at least two of these.

In one embodiment 29 of the invention, the method 1 is configured according to any of its embodiments 1 to 28, wherein the container layer in method step b) has a moisture content within a range from 0% to 20% by weight, based on the weight of the container layer. The container layer in method step b) preferably has a moisture content within a range from 3% 17% by weight, more preferably from 5% to 20% by weight, more preferably from 5% to 15% by weight, even more preferably from 5% to 12% by weight, most preferably from 5% to 9% by weight, based in each case on the weight of the container layer. The container layer more preferably has the aforementioned moisture content in method step b) in the case that the first polymer composition comprises, or most preferably consists of, the first multitude of polymer particles.

In one embodiment 30 of the invention, the method 1 is configured according to any of its embodiments 1 to 29, wherein the first polymer composition in method step b) has been electrically charged with respect to the container precursor wall. This is more preferably applicable in the case of powder coating with the first polymer composition. The first polymer composition here is preferably positively or negatively electrically charged.

In one embodiment 31 of the invention, the method 1 is configured according to any of its embodiments 13 to 30, wherein the further polymer composition has been electrically charged with respect to the container precursor wall in the superimposing operation with the further polymer composition. This is more preferably applicable in the case of powder coating with the further polymer composition. The further polymer composition here is preferably positively or negatively electrically charged.

In one embodiment 32 of the invention, the method 1 is configured according to any of its embodiments 1 to 31, wherein the container precursor wall in method step b) has been contacted with a shaped body, wherein the shaped body has been grounded. The container precursor is preferably held by the shaped body. For this purpose, the shaped body may preferably be configured in the form of a sleeve or a cup for receiving the container precursor, such that the shaped body partly surrounds the container precursor. This is preferred when the first polymer composition is being superimposed onto the container layer on the side facing the container precursor interior. Alternatively, the shaped body may be configured in the form of a rod or spike for receiving the container precursor, such that the shaped body projects into the container interior. This is preferred when the first polymer composition is being superimposed onto the container layer on the side remote from the container precursor interior. The shaped body is preferably in electrically conductive form.

In one embodiment 33 of the invention, the method 1 is configured according to any of its embodiments 1 to 32, wherein the container precursor wall in method step b) has a distance of less than 1000 μm, preferably less than 100 μm, more preferably less than 10 μm, from a shaped body over at least 50%, preferably at least 50%, more preferably at least 70%, even more preferably at least 80%, most preferably at least 85%, in each case of its surface remote from the container precursor interior. Preferably, the container precursor wall is contacted with the shaped body in the aforementioned proportion of its surface remote from the container precursor interior. The shaped body here is preferably configured in the form of a sleeve or a cup for receiving the container precursor, such that the shaped body partly surrounds the container precursor. In method step b), the container precursor is preferably accommodated within the shaped body; the container precursor is more preferably partly surrounded by the shaped body. The shaped body is preferably in electrically conductive form.

In one embodiment 34 of the invention, the method 1 is configured according to any of its embodiments 1 to 33, wherein the first polymer composition or the further polymer composition or each of them in method step b) is released from a release device. A preferred release device comprises at least one nozzle. A further preferred release device is a spray head. Additionally or alternatively preferably, the release device is in the form of a lance. The lance may preferably be introduced at least partly into the container precursor. The release device is preferably in a form according to one embodiment of the apparatus of the invention.

In one embodiment 35 of the invention, the method 1 is configured according to its embodiment 34, wherein the release device in method step b) is introduced into the container precursor interior at a speed within a range from 0.5 to 100 m/s, preferably from 5 to 100 m/s, more preferably from 10 to 100 m/s. Alternatively or additionally, the container precursor in method step b) rotates at a speed within a range from 500 to 2000 revolutions per minute, preferably from 1000 to 2000 revolutions per minute, more preferably from 1200 to 2000 revolutions per minute, most preferably from 1400 to 1800 revolutions per minute.

In one embodiment 36 of the invention, the method 1 is configured according to its embodiment 34 or 35, wherein the release device in method step b) is introduced into the container precursor interior in one direction, wherein the container precursor interior has a dimension in that direction, wherein the release device is introduced into the container precursor interior in method step b) to an extent of 50% to 95%, preferably to an extent of 60% to 95%, more preferably to an extent of 70% to 90%, of that dimension.

In one embodiment 37 of the invention, the method 1 is configured according to any of its embodiments 1 to 36, wherein the container precursor wall in method step a) comprises a mouth region that forms the container precursor opening, wherein the container layer in method step b) is superimposed at least over the entire mouth region with the first polymer composition or with the further polymer composition or with both.

In one embodiment 38 of the invention, the method 1 is configured according to any of its embodiments 1 to 38, wherein the container layer in method step a) has an average thickness within a range from 100 to 2000 μm, preferably from 150 to 1800 μm, more preferably from 200 to 1500 μm, even more preferably from 250 to 1300 μm, most preferably from 300 to 1000 μm.

In one embodiment 39 of the invention, the method 1 is configured according to any of its embodiments 1 to 38, wherein the container layer in method step a) is at no point thinner than 100 μm, preferably than 150 μm, more preferably than 200 μm, more preferably than 250 μm, more preferably than 300 μm, more preferably than 400 μm, more preferably than 450 μm, most preferably than 500 μm. The lack of such thin parts of the container layer increases the mechanical stability of the container, especially against compression.

In one embodiment 40 of the invention, the method 1 is configured according to any of its embodiments 1 to 39, wherein the container precursor in method step a) has a compressive strength within a range from 100 to 250 N, preferably from 150 to 250 N.

A contribution to the achievement of at least one of the objects of the invention is made by an embodiment 1 of a container 2, obtainable from the container precursor by the method 1 according to any of its embodiments. The container 2 of the invention, in a preferred embodiment, has the features of container 1 of the invention according to any of its embodiments.

A contribution to the achievement of at least one of the objects of the invention is made by an embodiment 1 of an apparatus 1 comprising, as constituents:
A) a holding device comprising a shaped body arranged and designed so as to hold a container precursor,
wherein the container precursor comprises a container precursor wall at least partly surrounding a container precursor interior,
wherein the container precursor wall
   a. has a container precursor opening, and
   b. comprises a container layer comprising a multitude of particles,
wherein the container precursor interior
   i. has a maximum diameter in a plane perpendicular to a height of the container precursor interior, and
   ii. has a diameter less than the maximum diameter of the container precursor interior at least in sections in the direction from the plane to the container precursor opening; and
B) a release device arranged and designed so as to release a polymer composition in such a way that the container layer is at least partly superimposed by the polymer composition.

The container layer preferably does not comprise any fold or any crease. Preferably, the release device and the holding device are arranged and designed to at least partly superimpose the container layer with the polymer composition on a side remote from the container precursor interior. Alternatively or additionally, the release device and the holding device are arranged and designed to at least partly superimpose the container layer with the polymer composition on a side facing the container precursor interior. The release device is preferably in a form according to one embodiment of the method 1 of the invention. A particularly preferred apparatus is a powder coating system.

In one embodiment 2 of the invention, the apparatus 1 is configured according to its embodiment 1, wherein the holding device and the release device are arranged and designed to superimpose the container layer with the polymer composition in a proportion within a range from 1% to 100%, more preferably from 1% to 90%, more preferably from 1% to 80%, more preferably from 1% to 70%, more preferably from 1% to 60%, more preferably from 1% to 50%, even more preferably from 1% to 40%, even more preferably from 1% to 30%, even more preferably from 3% to 20%, most preferably from 5% to 15%, in each case of its surface remote from the container precursor interior.

In one embodiment 3 of the invention, the apparatus 1 is configured according to its embodiment 1 or 2, wherein the holding device and the release device are arranged and designed to superimpose the container layer with the polymer composition in a proportion within a range from 50% to 100%, more preferably from 60% to 100%, more preferably from 70% to 100%, more preferably from 80% to 100%, even more preferably from 90% to 100%, most preferably from 95% to 100%, in each case of its surface facing the container precursor interior.

In one embodiment 4 of the invention, the apparatus 1 is configured according to any of its embodiments 1 to 3, wherein the container precursor wall comprises a mouth region that forms the container precursor opening, wherein the holding device and the release device are arranged and designed to superimpose the container layer with the polymer composition at least over the entire mouth region on its side remote from the container precursor interior.

In one embodiment 5 of the invention, the apparatus 1 is configured according to any of its embodiments 1 to 4, wherein the shaped body has been grounded. The shaped body is preferably in electrically conductive form.

In one embodiment 6 of the invention, the apparatus 1 is configured according to any of its embodiments 1 to 5, wherein the shaped body is arranged and designed so as to hold the container precursor in such a way that the container precursor wall has a distance of less than 1000 μm, preferably less than 100 μm, more preferably less than 10 μm, from the shaped body over at least 50%, preferably at least 60%, more preferably at least 70%, even more preferably at least 80%, most preferably at least 85%, in each case of its surface remote from the container precursor interior. The shaped body is preferably arranged and designed to contact the container precursor wall over the aforementioned proportion of its surface remote from the container precursor interior. The shaped body here is preferably configured in the form of a sleeve or a cup for receiving the container precursor, such that the shaped body partly surrounds the container precursor. The shaped body is preferably in electrically conductive form.

In one embodiment 7 of the invention, the apparatus 1 is configured according to any of its embodiments 1 to 6, wherein the polymer composition comprises a multitude of polymer particles. In the context of this embodiment, the polymer composition is preferably a dispersion or a powder. In the case of the powder, the polymer composition preferably consists of the multitude of polymer particles. Moreover, in the case of the powder, the apparatus is preferably designed to superimpose the container layer by a powder coating operation. In a preferred embodiment, the polymer composition has a liquid content of less than 20% by weight, based on the weight of the polymer composition.

In one embodiment 8 of the invention, the apparatus 1 is configured according to its embodiment 7, wherein the multitude of polymer particles has a particle size distribution having a D₅₀ within a range from 10 to 100 μm, preferably from 10 to 90 μm, more preferably from 20 to 80 μm, most preferably from 30 to 70 μm.

In one embodiment 9 of the invention, the apparatus 1 is configured according to any of its embodiments 1 to 6, wherein the polymer composition comprises, preferably consists of, a polymer emulsion.

In one embodiment 10 of the invention, the apparatus 1 is configured according to any of its embodiments 1 to 9, wherein the polymer composition comprises a polymer in a proportion within a range from 50% to 100% by weight, preferably from 60% to 100% by weight, more preferably from 70% to 100% by weight, more preferably from 80% to 100% by weight, most preferably from 90% to 100% by weight, based in each case on the weight of the polymer composition.

In one embodiment 11 of the invention, the apparatus 1 is configured according to its embodiment 10, wherein the polymer is one selected from the group consisting of a polycondensate, a polyolefin, and a polyvinyl alcohol, or a combination of at least two of these.

In one embodiment 12 of the invention, the apparatus 1 is configured according to any of its embodiments 1 to 11, wherein the shaped body is mounted so as to be rotatable about an axis, wherein the holding device also comprises a drive unit arranged and designed to rotate the shaped body about the axis. Preferably, the drive unit is arranged and designed to rotate the shaped body about the axis at a speed within a range from 500 to 2000 revolutions per minute, preferably from 1000 to 2000 revolutions per minute, more preferably from 1200 to 2000 revolutions per minute, most preferably from 1400 to 1800 revolutions per minute.

In one embodiment 13 of the invention, the apparatus 1 is configured according to any of its embodiments 1 to 12, wherein the release device comprises at least one nozzle. The nozzle here preferably serves to atomize the polymer composition. In this way, it is especially preferably possible in the case of powder coating with the polymer composition in powder form to obtain a very homogeneous cloud of powder. A preferred nozzle is one selected from the group consisting of an impact plate nozzle, a flat jet nozzle, a finger nozzle, and a rotary bell, or a combination of at least two of these. In the case of powder coating with the polymer composition in powder form, the nozzle is preferably chosen appropriately for the method of electrical charging of the powder. Preferably, the release device takes the form of a lance, wherein the lance comprises at least one nozzle, preferably a multitude of nozzles, on an end face and at least one nozzle, preferably at least one, preferably slot-shaped, nozzle running around the lance along a circumference of its shell surface.

In one embodiment 14 of the invention, the apparatus 1 is configured according to any of its embodiments 1 to 13, wherein the release device is arranged and designed so as to be movable relative to the shaped body, such that the release device can be introduced at least partly, preferably through the container opening, into the container precursor interior of the container precursor held by the shaped body.

In one embodiment 15 of the invention, the apparatus 1 is configured according to its embodiment 14, wherein the release device is arranged and designed so as to be movable relative to the shaped body at a speed within a range from 0.5 to 100 m/s, preferably from 5 to 100 m/s, more preferably from 10 to 100 m/s.

In one embodiment 16 of the invention, the apparatus 1 is configured according to its embodiment 14 or 15, wherein the release device is arranged and designed so as to be movable in one direction, wherein the container precursor interior has a dimension in that direction, wherein the release device is arranged and designed so as to be movable such that the release device can be inserted into the container precursor interior to an extent of 50% to 95%, preferably to an extent of 60% to 95%, more preferably to an extent of 70% to 90%, of that dimension.

In one embodiment 17 of the invention, the apparatus 1 is configured according to any of its embodiments 1 to 16, wherein the apparatus additionally comprises a charging device, wherein the charging device is arranged and designed to electrically charge the polymer composition relative to the shaped body. A preferred charging device is arranged and designed to electrically charge the polymer composition relative to the shaped body by applying a high voltage or by friction or by both. Electrical charging by applying a high voltage is preferably effected as a corona discharge or by ionization or both, preference being given to ionization. The charging device is preferably arranged and designed to apply a high voltage to the release device. Preferred electrical charging by friction is effected as triboelectric charging or as electrokinetic charging or both. The charging device is preferably arranged and designed for one or more of the aforementioned charging methods. This is especially preferred when the polymer composition comprises and more preferably consists of a multitude polymer particles, very particularly when the polymer composition is a powder.

In one embodiment 18 of the invention, the apparatus 1 is configured according to any of its embodiments 1 to 17, wherein the apparatus additionally comprises a heating device, wherein the heating device is arranged and designed to increase a temperature of the polymer composition superimposing the container layer. In a preferred embodiment, the polymer composition has a melting temperature, wherein the heating device is arranged and designed to raise the polymer composition superimposing the container layer to or above the melting temperature. In a preferred embodiment, the polymer composition has a melting temperature, wherein the heating device is arranged and designed to raise the polymer composition superimposing the container layer to a temperature of not more than 15° C., preferably not more than 10° C., above the melting temperature. In a further preferred configuration, the heating device is arranged and designed to raise the polymer composition superimposing the container layer to a temperature of not more than 200° C., preferably not more than 180° C. The aforementioned figures are particularly preferred in the case that the polymer composition comprises or consists of a multitude of polymer particles. In a further preferred embodiment, the heating device is arranged and designed to increase the temperature of the polymer composition superimposing the container layer in such a way that a liquid content of the polymer composition can be reduced. This is particularly preferred in the case that the polymer composition comprises or consists of a dispersion or a polymer emulsion.

In one embodiment 19 of the invention, the apparatus 1 is configured according to any of its embodiments 1 to 18, wherein the apparatus is designed to perform the method 1 according to any of its embodiments. Further preferably, the method 1, in a preferred configuration, is configured to be performed with the apparatus 1 according to any of its embodiments.

A contribution to the achievement of at least one of the objects of the invention is made by an embodiment 1 of a method 2 comprising, as method steps,
I) providing the container 1 or 2, in each case according to any of its embodiments;
II) filling the container with a fluid; and
III) closing the container by joining the container to a closure.
   Method steps II) and III) are preferably conducted in a filling machine. Before method step II), the container is preferably at least partly sterilized, preferably on the surface of the container wall facing the container interior.

In one embodiment 2 of the invention, the method 2 is configured according to its embodiment 1, wherein the closure is at least partly sealed to the container. Preferably, the closure is sealed to the container by means of the outer polymer layer or the inner polymer layer or both as sealant.

A contribution to the achievement of at least one of the objects of the invention is made by an embodiment 1 of a closed container obtainable by the method 2 according to its embodiment 1 or 2. The closed container of the invention, in a preferred embodiment, has the features of container 1 of the invention according to any of its embodiments.

A contribution to the achievement of at least one of the objects of the invention is made by an embodiment 1 of a use 1 of a filling machine for filling and closing the container 1 or 2, in each case according to any of its embodiments. Preferably, the filling machine is used for performance of method 2 of the invention according to any of its embodiments. A filling machine refers here to a machine or automatic system designed to dispense a fluid, preferably a food or drink product or a medicament or both, into a multitude of the containers of the invention. Moreover, the filling machine is preferably designed for closing of the containers after the filling. The filling or closing or both is preferably effected in a very substantially automated manner.

A contribution to the achievement of at least one of the objects of the invention is made by an embodiment 1 of a use 2 of the container 1 or 2, in each case according to any of its embodiments, for storing a fluid, preferably a food or drink product or a medicament or both. The storing here is preferably effected at an ambient temperature within a range from 1 to 18° C., more preferably from 3 to 15° C., most preferably from 5 to 15° C. In addition, the storing can be effected here over a long period in a warehouse, or else for offering for sale in a sales space, or for transportation of the container.

A contribution to the achievement of at least one of the objects of the invention is made by an embodiment 1 of a use 3 of a polymer composition for at least partial coating of a container precursor wall that partly surrounds a container precursor interior of a container precursor,

wherein the container precursor wall
a. has a container precursor opening, and
b. comprises a container layer comprising a multitude of particles,
   wherein the container precursor interior
i. has a maximum diameter in a plane perpendicular to a height of the container precursor interior, and
ii. has a diameter less than the maximum diameter of the container precursor interior at least in sections in the direction from the plane to the container precursor opening.
   Preferably, the container layer takes the form according to any embodiment of the container 1 of the invention or of the method 1 of the invention. Additionally or alternatively, the polymer composition is preferably configured according to the first polymer composition of any embodiment of the method 1 of the invention. Additionally or alternatively, the container precursor is preferably configured according to any embodiment of the method 1 of the invention. Preferably, the at least partial coating is a powder coating operation. The container layer preferably does not comprise any fold or any crease.

In one embodiment 2 of the invention, the use 3 is configured according to its embodiment 1, wherein the coating is effected on a side of the container precursor wall remote from the container precursor interior.

In one embodiment 3 of the invention, the use 3 is configured according to its embodiment 1 or 2, wherein the coating is effected on a side of the container precursor wall facing the container precursor interior.

A contribution to the achievement of at least one of the objects of the invention is made by an embodiment 1 of a use 4 of a powder coating system for at least partial coating of a container precursor wall that partly surrounds a container precursor interior of a container precursor with a polymer layer,

wherein the container precursor wall
a. has a container precursor opening, and
b. comprises a container layer comprising a multitude of particles,
   wherein the container precursor interior
i. has a maximum diameter in a plane perpendicular to a height of the container precursor interior, and
ii. has a diameter less than the maximum diameter of the container precursor interior at least in sections in the direction from the plane to the container precursor opening.
   Preferably, the coating is effected on a side of the container precursor wall remote from the container precursor interior or on a side of the container precursor wall facing the container precursor interior or on both. Preferably, the container layer takes the form according to any embodiment of the container 1 of the invention or of the method 1 of the invention. Additionally or alternatively, the container precursor is preferably configured according to any embodiment of the method 1 of the invention. A preferred powder coating system comprises one selected from the group consisting of a release device, a holding device, and a charging device, each according to any embodiment of the apparatus of the invention, or a combination of at least two of these. The polymer layer preferably takes the form according to any embodiment of the container 1 of the invention or of the method 1 of the invention. A further aspect of the invention relates to the use of the apparatus 1 of the invention for at least partial coating of the container layer of the container. A preferred coating method is powder coating.

In one embodiment 4 of the invention, the use 3 is configured according to its embodiment 1, wherein the particles of the multitude of particles are fibers. In one embodiment 2 of the invention, the use 4 is configured according to its embodiment 1, wherein the particles of the multitude of particles are fibers.

In one embodiment 5 of the invention, the use 3 is configured according to its embodiment 4, wherein the fibers are plant fibers. In one embodiment 3 of the invention, the use 4 is configured according to its embodiment 2, wherein the fibers are plant fibers.

In one embodiment 6 of the invention, the use 3 is configured according to its embodiment 4 or 5, wherein the fibers comprise, preferably consist of, a chemical pulp or a mechanical pulp or both. In one embodiment 4 of the invention, the use 4 is configured according to its embodiment 2 or 3, wherein the fibers comprise, preferably consist of, a chemical pulp or a mechanical pulp or both.

Features which are described as preferred in one category of the invention, for example for the container 1, are likewise preferred in an embodiment of the further categories of the invention, for example an embodiment of the method 1 of the invention.

### Container

For the container of the invention, any container form which is known to the person skilled in the art and seems suitable in connection with the invention, especially for food or drink product or medicament containers, is an option. The container of the invention here, especially by virtue of the presence of the container layer, is in dimensionally stable and rigid form. A container is an article having a cavity in its interior that especially serves the purpose of separating its contents from its environment. A vessel is an article having a stiff and rigid shell that may contain contents of different consistency. There is accordingly a fundamental distinction between containers and vessels. A container is preferably relatively impervious to a medium for which it is constructed, but not necessarily to other media. The container of the invention is preferably a container for a fluid. A preferred fluid here is a granular material or a liquid, particular preference being given to a liquid. Moreover, the container of the invention is preferably also a vessel. Preferably, the container wall comprises a container opening. The container opening is preferably arranged and designed to remove some of the contents of the container from the container interior, preferably by pouring out or tipping out or both. In this case, a ratio of an area content of an opening area of the container opening to an area content of an entire surface of the container wall remote from the container interior is preferably within a range from 0.001 to 0.2. Further preferably, the container precursor comprises a container precursor opening from which the container opening is obtainable. In this case, a ratio of an area content of an opening area of the container precursor opening to an area content of an entire surface of the container precursor wall remote from the container precursor interior is within a range from 0.001 to 0.2.

The container of the invention preferably comprises a container wall at least partly surrounding a container interior, where the container wall has a container opening, where the container interior has a maximum diameter in a plane perpendicular to a height of the container interior, where the container interior has a diameter less than the maximum diameter of the container interior at least in sections in the direction from the plane to the container opening. The height of the container interior is preferably a greatest extent of the container interior in any Cartesian spatial direction. Further preferably, the height of the container interior extends from the container opening to a section of the container wall opposite the container opening, which is preferably a base of the container. Accordingly, the container interior narrows at least in sections in the direction from the plane of the maximum diameter of the container interior toward the container opening.

More preferably, the container of the invention takes the form of a bottle. The container precursor preferably also already has the shape of a bottle. According to the above definitions, a bottle is a container for a fluid and simultaneously also a vessel. Bottles typically, but not necessarily, have a relatively small maximum external diameter relative to their height, and a flat base. The base is preferably arranged opposite a bottle opening, which in the case of the bottle as container is the above container opening. The height of the bottle here is preferably more by a factor of at least 2 than a maximum external diameter of the bottle in a plane perpendicular to the height. The flat base is preferably designed to be able to place the bottle on a flat surface in a stable manner. Bottles typically have a bottle body and a mouth region. The bottle body is designed to provide an internal volume to accommodate a fluid. For this purpose, the bottle body preferably forms at least 80% of a volume of the bottle interior. The mouth region forms a bottle opening, which in the case of the bottle as container is the above container opening. In addition, the bottle often but not necessarily comprises a bottle neck that connects the bottle body to the mouth region. The bottle neck is designed to connect the bottle body to the mouth region, such that a fluid can flow out of the bottle body into the mouth region. The bottle neck preferably has a smaller internal diameter at every point than the bottle body, and further preferably also than the mouth region of the bottle. The internal diameter of the mouth region here may be greater than, less than or equal to the maximum internal diameter of the bottle body.

The container wall or container layer or both of the container of the invention is preferably in one-piece form. In this connection, the container wall or container layer or both preferably does not have any joining site. A joining site here is a region in which two or more separate parts are joined to one another within the meaning of standard DIN 8580. For this purpose, the joining site may include a material that has been used as a shapeless substance for the joining. Illustrative shapeless substances are adhesives and sealants. Illustrative modes of joining are adhesive bonding, sealing and compressing. A joining site is often an elongated region that often runs around the circumference in its longitudinal or transverse direction, or across its height, which is also referred to as a seam. Further preferably, the container wall or container layer or both also has no joining site at which a part has been joined to itself. More preferably, the container of the invention takes the form of a bottle, the base or mouth region of which or both has preferably been formed in one piece together with the bottle body thereof. Further preferably, the bottle body as such is in one-piece form. Additionally preferably, the bottle body does not comprise any joining site.

### Mouth Region

The container wall preferably comprises a mouth region of the container. This mouth region especially forms an opening, also called container opening herein, of the container. This opening is preferably designed for pouring out or tipping out, or both, contents of the container. In the case of a bottle as container, the bottle body typically merges into the mouth region via a bottle neck. The mouth region in this case is specifically the region of the container wall that forms the opening of the container. Often, the mouth region comprises a thread on a side remote from the container interior for screwing on a lid. In addition, the mouth region may surround the opening in the form of a collar. More particularly, the mouth region of a bottle as container is the region of the container wall that typically comes into contact with the lips when drinking directly from the bottle by placing the lips against the bottle. The mouth region of the container is preferably obtainable from a mouth region of the container precursor. It is further preferable here that the container opening is obtainable from a container precursor opening formed by the container precursor wall in the mouth region of the container precursor.

### Container Wall

The container wall of the container of the invention takes the form of a two- or multilayer composite comprising at least the container layer and the first polymer layer as layers of a layer sequence. A form of words in which a layer sequence comprises enumerated layers means that at least the layers specified are present in the sequence specified. This form of words does not necessarily mean that these layers follow on directly from one another. Unless stated otherwise, in a layer sequence, the layers may follow one another indirectly, i.e. with one or at least two intermediate layers, or directly, i.e. with no intermediate layer. This is the case especially in the form of words in which one layer superimposes another layer. A form of words in which two layers adjoin one another or one of the layers has been coated onto the other means that these two layers follow on from one another directly and hence with no intermediate layer. Moreover, layers coated onto one another have been joined to one another. Two layers are joined to one another when their adhesion to one another extends beyond van der Waals attraction forces.

An edge formed by the container wall preferably runs around the container opening of the container of the invention. In the case of a circular container opening, the edge is preferably in the form of a circular ring. The edge cannot be unambiguously assigned to an interior or exterior of the container. It thus remains ambiguous whether this edge faces or is remote from the container interior. Consequently, this edge may be superimposed by the inner polymer layer or the outer polymer layer or even by both. If the container layer is superimposed at the edge with the inner polymer layer or the outer polymer layer or with both, it is preferably possible to join a closure, preferably in the form of a film, by means of the inner polymer layer or the outer polymer layer or both as sealant to the container by sealing.

### Container Layer

The container layer of the container of the invention imparts a rigid shape and mechanical stability thereto. The container layer here essentially defines the shape of the container. The container layer is preferably the layer of the container wall that serves as a stiff and rigid shell that preferably also makes the container of the invention a vessel. Further preferably, the container layer has a metal content of less than 20% by weight, preferably less than 10% by weight, most preferably less than 5% by weight, based in each case on the weight of the container layer. More preferably, the container layer is essentially metal-free. The container layer preferably serves as support for layers in addition to the container layer in the container wall, especially for the polymer layer, especially in the case of a configuration of the polymer layer as inner polymer layer or as outer polymer layer or both. Preferably in accordance with the invention, the container layer preferably does not comprise any fold or any crease. Preferably, the container layer at a moisture content of 7% by weight would break in the attempt to fold or to crease this layer by an angle of 90°. Preferably, the container layer extends over the entire surface of the container wall. More preferably, the container layer is in one-piece form. In this connection, the container layer preferably does not have any joining site. More preferably, the container layer is obtained from a pulp as composition, most preferably in one-piece form. For this purpose, the pulp has preferably been at least partly dewatered, shaped, pressed and heated. The container layer preferably has a water absorption within a range from 0% to 20% by weight, preferably from 0% to 15% by weight, more preferably from 0% to 10% by weight, of its dry weight. The container layer preferably has an average density within a range from 0.4 to 2.0 g/cm³, preferably from 0.4 to 1.8 g/cm³, more preferably from 0.4 to 1.6 g/cm³, more preferably from 0.4 to 1.4 g/cm³, more preferably from 0.4 to 1.2 g/cm³, more preferably from 0.4 to 1.0 g/cm³, even more preferably from 0.5 to 0.9 g/cm³, most preferably from 0.6 to 0.8 g/cm³.

### Particles/Fibers

Useful particles for the multitude of particles in the container layer include all particles that seem suitable to the person skilled in the art for the use of the invention. The particles are preferably elongated. Preferred particles are fibers. Useful fibers are any fibers that seem suitable to the person skilled in the art for the use of the invention, especially all fibers known in paper, cardboard or paperboard production. Fibers are linear elongate structures that have a ratio of length to diameter or thickness of at least 3:1. For some fibers, the aforementioned ratio is not greater than 10:1. Preferred fibers are plant fibers. Plant fibers is a collective term for fibers of plant origin. In plants, plant fibers occur as a vascular bundle in the stalk or stem, in the bark (for instance in the form of bast) and as seed shoots. A subdivision is made in DIN 60001-1: 2001-05 Textile fibres-Part 1: “Natural fibres and letter codes”, Beuth Verlag, Berlin 2001, p. 2 into seed fibers, bast fibers and hard fibers, or in DIN EN ISO 6938: 2015-01 “Textiles-Natural fibres-Generic names and definitions”, Beuth Verlag, Berlin 2015, p. 4. into seed fibers, bast fibers, leaf fibers and fruit fibers, which thus implements a division of the hard fibers. Fibers that are preferred in the context of the invention include a chemical pulp or a mechanical pulp or both; the fibers preferably consist thereof. Preferred fibers have an average fiber length within a range from 0.5 to 5 mm, more preferably from 0.5 to 4 mm, more preferably from 1 to 3 mm, most preferably from 1 to 2 mm.

### Chemical Pulp

Chemical pulp typically refers to the fibrous mass formed in the chemical digestion of plant fibers that typically consists predominantly of cellulose.

### Mechanical Pulp

Mechanical pulp refers to the substance that is typically used for the production of particular types of paper. It is obtained from wood and, unlike chemical pulp, typically contains relatively high proportions of lignin. Mechanical pulp can be detected by staining the lignin present red with phloroglucinol solution in hydrochloric acid and hence distinguished from chemical pulp. Wurster's blue and red (named for Casimir Wurster) and aniline sulfate have frequently also been used for the purpose. The high lignin content of mechanical pulp can lead to yellowing in the case of paper (wood-pulp paper) produced from mechanical pulp. The wood from which the mechanical pulp is obtained typically consists mainly of lignocellulose. Lignocellulose consists of cellulose molecules aggregated to form fibers. A matrix of lignin permeates the cellulose, giving rise to a pressure- and tear-resistant composite. In the production of mechanical pulp, the wood is shredded by various methods. Mechanical pulp is produced by mechanical and/or thermal and/or chemical methods of wood digestion. According to these modes of production, a distinction is made between mechanical pulp MP, which is produced by merely mechanical methods of wood digestion; and thermomechanical pulp (TMP), which is produced by wood digestion comprising mechanical and thermal and optionally also chemical steps. The aforementioned methods of wood digestion comprising mechanical and thermal and optionally also chemical steps are also referred to as refiner methods. A preferred thermomechanical pulp is a chemithermomechanical pulp (CTMP). The mechanical methods of wood digestion especially include grinding methods such as wood grinding and pressure grinding. In the context of the invention, preference is given to mechanical pulp MP. A preferred mechanical pulp MP is a ground wood or a pressure-ground wood or both. Alternatively or additionally preferably, the mechanical pulp has been produced from a soft wood. Soft wood, as opposed to hard wood, refers to lighter wood, for example having an oven-dry density below 0.55 g/cm³ (for example willow, poplar, linden and nearly all coniferous woods). A particularly preferred soft wood is spruce wood. The term soft wood should not be used equivalently to the English term “softwood”. “Softwood” has to be translated into German as “Nadelholz” and thus refers primarily to the origin of the wood and merely indirectly to the wood's characteristics because there are also relatively hard coniferous woods.

### Polymer

Any polymer known to the person skilled in the art that seems suitable for the use of the invention is an option for the polymer described herein, the first polymer or else the further polymer or else the polymer of the polymer composition. The polymer of the inner polymer layer is more preferably suitable for contact with a food or drink product. Polymers that are suitable to the container of the invention sufficient watertightness for storing aqueous liquid in the container over a period of several weeks or even several months are preferred herein. Further preferably, the polymer is coatable onto the container layer by means of a suitable method, for example by emulsion, dispersion or powder coating, such that a very substantially continuous and homogeneous layer is obtained. Particular preference is given here to powder coating. The polymer is preferably one selected from the group consisting of a polycondensate, a polyolefin, and a polyvinyl alcohol, or a combination of at least two of these. A preferred polyolefin is a polyethylene (PE) or a polypropylene (PP) or both. A preferred polycondensate is a polyester or polyamide (PA) or both. A preferred polyester is a polyalkylene terephthalate or a polylactide (PLA, also colloquially called polylactic acid) or both. A preferred polyalkylene terephthalate is polybutylene terephthalate (PBT) or a polyethylene terephthalate (PET). A preferred polyvinyl alcohol is a vinyl alcohol copolymer. A preferred vinyl alcohol copolymer is an ethylene-vinyl alcohol copolymer (EVOH).

### Container Precursor

The container 1 of the invention described herein is preferably obtainable from the container precursor, preferably by method 1 of the invention from use 3 or 4. The container precursor preferably already essentially has the shape of the container to be produced from the container precursor. Especially preferably, the container layer in the container precursor essentially already has the stiffness that it has in the container obtainable therefrom. The container precursor preferably comprises a container precursor wall at least partly surrounding a container precursor interior, where the container precursor wall has a container precursor opening, where the container precursor interior has a maximum diameter in a plane perpendicular to a height of the container precursor interior, where the container precursor interior has a diameter less than the maximum diameter of the container precursor interior at least in sections in the direction from the plane to the container precursor opening. The height of the container precursor interior is preferably a greatest extent of the container precursor interior in any Cartesian spatial direction. Further preferably, the height of the container precursor interior extends from the container precursor opening to a section of the container precursor wall opposite the container precursor opening, which is preferably a base of the container precursor. Accordingly, the container precursor interior narrows at least in sections in the direction from the plane of the maximum diameter of the container precursor interior toward the container precursor opening. The region of the container precursor wall that forms the container precursor opening is also referred to herein as mouth region. The container precursor wall is preferably in one-piece form. In this connection, the container precursor wall preferably does not have any joining site. What is meant by a joining site is described above for the container and is analogously applicable here too. More preferably, the container precursor of the invention takes the form of a bottle, the base or mouth region of which or both has preferably been formed in one piece together with the bottle body thereof. Further preferably, the bottle body as such is in one-piece form. Additionally preferably, the bottle body does not comprise any joining site. Further preferred shapes have been described above for the container.

### Fluid

A fluid is understood to mean a free-flowing medium. These especially include liquids; gases; and granular materials such as powders or granules; and mixtures of at least two of the above. A preferred fluid is a food or drink product or a medicament or both.

### Particle Size Distribution

The particle size distribution of the multitude of particles of the polymer composition is specified herein using the D₅₀. The D₅₀ indicates the particle diameter in μm for which 50% by weight of the particles of the multitude of particles are smaller than said particle diameter. The particle diameter here is a length of the longest straight line having a starting point and an endpoint on the surface of the particle, with the straight line intersecting a geometric centroid of the particle.

### Fold/Crease

Creasing is the production of a sharp folded edge called a crease (also crease line or crease break). In the case of creasing, this production is effected with the aid of a tool or a machine. If the folded edge is created without tools, this is referred to as folding and the folded edge is referred to as a fold. Folding or creasing is typically effected along grooves. The folding/creasing typically weakens the mechanical integrity of the corresponding layer along the fold/crease such that regions of the layer adjoining the fold/crease can be moved with respect to one another in the manner of a hinge joint, in that an angle formed by the regions is reduced. The regions come to rest here against one another at an angle of 0°. In the case of a fiber-containing layer, the fibers are typically broken at least partly along the fold/crease. Preferably in accordance with the invention, the container layer does not comprise any fold or any crease.

### Closure

A useful closure for the container of the invention or the closed container is any closure which is known to the person skilled in the art and seems suitable for the respective container. The closure here may be in single- or multipart form. The closure is designed to close the container opening of the container. For this purpose, the closure is designed to cover the container opening, and the container opening to be joined to the container in a covering manner. The joining here can be effected, for example, by screwing, sealing or else compression. A preferred closure comprises a lid. A preferred lid is a screwtop lid or a crown cap or both. Additionally or alternatively, the closure preferably comprises a film. The film preferably consists of a plastic or a metal or both and is further preferably joined to the container, preferably sealed or adhesively bonded or both. The film here may especially consist of a multilayer composite. A preferred lid consists of a plastic or a metal or both.

### Powder Coating

Powder coating is a coating method in which a material is coated with a powder, preferably a polymer powder, by means of electrostatic attraction forces. For this purpose, an electrical charge differential is generated between the polymer composition and the container layer. For that purpose, the polymer composition is preferably positively or negatively electrically charged. In addition, the shaped body here has preferably been grounded, and hence preferably so has the container precursor that has been contacted with the shaped body, preferably held by the shaped body. In the prior art, powder coating is known for coating of conductive and nonabsorptive, especially metallic, materials. However, the container layer of the invention as such, especially in the case of a low residual moisture content, is preferably electrically nonconductive and additionally absorptive. These properties fundamentally do not suggest the use of a powder coating process to the person skilled in the art for coating of the polymer layer onto the container layer. Firstly, the person skilled in the art must expect from his common art knowledge that the polymer particles would not adhere sufficiently to the container layer. Secondly, and even if sufficient adhesion could be achieved, the person skilled in the art would have to expect that, on melting of the polymer particles, this polymer melt would be absorbed by the container layer and hence no polymer layer would be obtained, or would be obtainable only through use of a greater amount of polymer that would undesirably increase the intrinsic weight of the container. By means of particular embodiments of the method of the invention, it has surprisingly been possible to apply a powder coating method advantageously for superimposing the polymer layer.

### Food or Drink Product

The present container is preferably a food or drink product container. Food and drink products include all kinds of food and drink known to those skilled in the art for human consumption and also animal feeds. A preferred food or drink product is a fluid, i.e. free-flowing. Free-flowing substances are liquids; gases; granular materials, for example powders or granules; and mixtures of at least two of the above. It is also possible here for solids to be present in the liquid, for example but not necessarily forming a suspension. A preferred liquid is a beverage, for example a juice, a nectar, a milk product or a soft drink. A further preferred liquid is a sauce or a soup. The abovementioned liquids are preferably in the liquid state of matter above 5° C.

### Hydrophobizing Agent

A hydrophobizing agent preferred herein comprises an alkyl ketene dimer (AKD) or an alkenylsuccinic anhydride (ASA) or both. The hydrophobizing agent preferably consists of the aforementioned compound(s).

### Flow Agent

A preferred flow agent is a polyamine, preferably an aliphatic polyamine. One example of a flow agent is commercially available as Eka ATC 4150 from Eka Chemicals. The flow agent is preferably an agent that modifies flow properties of the composition. The flow agent is added to the composition preferably as an aqueous solution, more preferably as an aqueous cationic polymer solution.

### TEST METHODS

The following test methods were used within the context of the invention. Unless stated otherwise, the measurements were conducted at an ambient temperature of 23° C., an ambient air pressure of 100 kPa (0.986 atm) and a relative air humidity of 50%.

### Determining the Moisture Content (Also Residual Moisture Content Herein) of the Composition, of the Blank Wall and of the Container Layer

The moisture content is determined to the standard DIN EN ISO 287:2009-09 with the aid of a heated cabinet. In this determination, either 1000 ml of the composition are taken as a sample, weighed and dried to constant mass in the heated cabinet at 105° C., or 10 blanks or 10 container precursors or 10 containers are weighed and dried to constant mass in the heated cabinet at a temperature of 105° C. and the arithmetic mean is formed over the 10 blanks or container precursors or containers.

### Proportion of Solids and Solids-Forming Additives

The proportion of solids in the container layer or of solids and solids-forming additives collectively in the composition is likewise determined by employing the standard DIN EN ISO 287:2009-09. The proportion of the particles is calculated here by the following equation:

% by weight of the particles=m₁/m₀×100

In particular, the particles of the multitude of particles belong here to the solids.

### Average Layer Thickness of a Polymer Layer

The layer thickness of a sample having an area of 0.5 cm² is determined by means of a scanning electron microscope (SEM). For this purpose, a cross section through the layer structure to be determined is conducted manually with a blade (Leica Microtome Blades 819). The cross section is sputtered with gold (Cressington 108auto from Cressington Scientific Instruments Ltd., Watford, UK) and then analyzed by SEM (Quanta 450, FEI Deutschland GmbH, Frankfurt) under high vacuum (p<7.0·10⁻⁵ Pa). The layer thicknesses of the individual layers are ascertained and read off with the “xT Microscope Control” software, version 6.2.11.3381, FEI Company, Frankfurt, Germany. To determine the average thickness, three samples are taken, the layer thickness in each sample is determined as described above, and the arithmetic mean is formed.

### Average Thicknesses and Densities of the Blank Wall and the Container Layer

The average thickness and density of the blank wall and the container layer are determined by taking 5 samples having the dimensions of about 1.5 cm×1.5 cm from the blank wall or container layer. The average thickness and density of the blank wall or container layer are determined according to standard DIN EN ISO 534:2012-02 in accordance with the scope of application under point 1a) “the measurement of a single sheet of paper or board as a single sheet thickness”. What is reported here as the average density is the apparent sheet density d_{S} according to point 10.3.1 of the standard.

### Compressive Strength

5 containers are used for this test. The test serves to ascertain the compression resistance along the longitudinal axis of the container and can be used to assess the durability of containers in the static case of storage and in the dynamic case of transport. Compression pressure testing is conducted on the individual containers in accordance with DIN EN ISO 2233:2000 and DIN EN ISO 12048. The test instrument used is a TIRAtest 28025 (Tira GmbH; 96528 Schalkau, Germany). The average of the maximum crush load (load value) is determined. This describes the value that leads to failure of the containers.

### Water Vapor Permeation Rate

Water vapor permeation rate is determined according to standard ASTM F1249-13. The container to be examined is stuck to a holder with a 2-component adhesive (5 minute epoxy, ITW Devcon, Kiel, Germany) and connected to the measuring instrument. The measurement area of the sample corresponds to the internal area of the sample. The measurements are conducted at an ambient temperature of 23° C., an ambient air pressure of 100 kPa (0.986 atm) and a relative air humidity of 50% on one side of the sample and of 0% on the other side of the sample. The test instrument is a Permatran-W Model 3/33 from Mocon, Neuwied, Germany. For the measurements, samples at ambient temperature are used. Further settings and factors that affect the measurement—especially the others listed under point 12 of the standard ASTM F1249-13—are defined by the measuring instrument used and the proper use and maintenance thereof according to the manufacturer's handbook. The value obtained for the water vapor permeation rate is converted to cm² of container wall (inside) and year.

### Water Absorption of the Container Layer

Water absorption capacity is determined according to standard DIN EN ISO 535:2014. The method is conducted here by means of the Cobb 600 provisions, wherein the test area is 16 cm².

### Average Fiber Length

Average fiber length is determined by dissolving the sample in water and analyzing with a Metso Fractionator, Metso Germany GmbH, Leuna, Germany.

### D₅₀ of a Particle Size Distribution

The particle size distribution is determined according to standard ISO 13320:2009 with the aid of an SALD 7101 particle size analyzer from Shimadzu, Duisburg.

The invention is described in more detail hereinafter by examples and drawings, although the examples and drawings do not imply any restriction of the invention. Moreover, the drawings, unless stated otherwise, are not to scale.

### Pulp

A pulp is provided with a fiber content of 0.6% by weight, and additives with a proportion of EKA DR25 SF content (AKD from Eka Chemicals AB, Bohus, Sweden) of 0.02% by weight and a proportion of EKA ATC 4160 content (polyamine from Eka Chemicals AB, Bohus, Sweden) of 0.0025% by weight, and a residue of water. The fibers here are ground wood fibers having an average fiber length of 1.5 mm.

### Negative Mold of the Container Blank

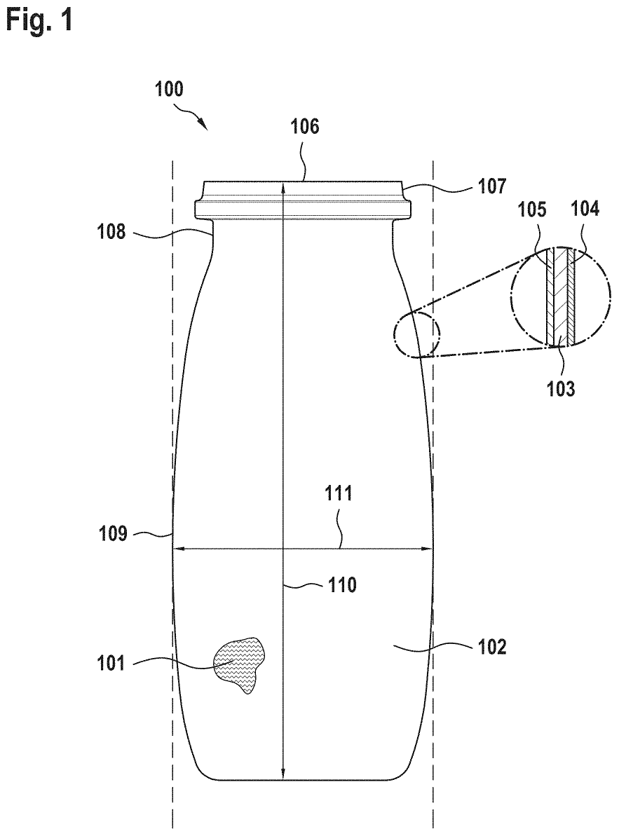

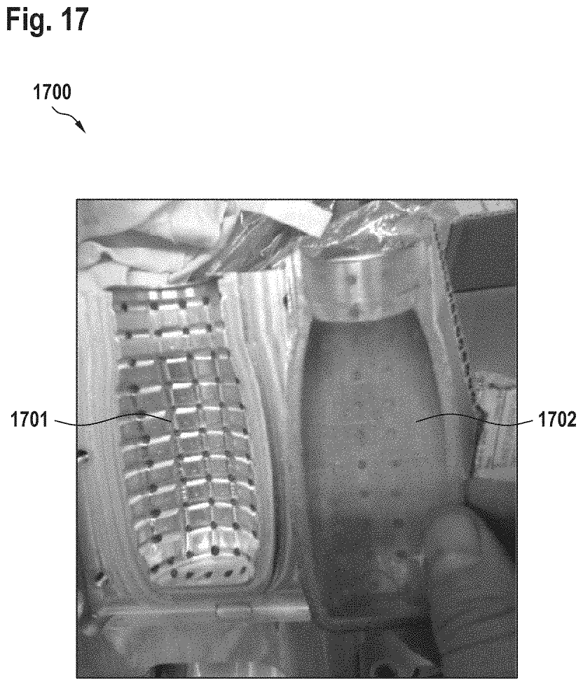

In addition, a negative mold of a container blank of the container precursor to be produced is provided. The container precursor is a precursor of a container which is a bottle as shown in FIG. 1. The negative mold of the container blank consists of half-shells each having a two-part construction. Each half-shell is also composed of a plastic carrier having a multitude of holes of several millimeters in diameter and a sieve mold inserted therein, composed of a metal sieve with mesh size 0.5 mm. The sieve mold here forms a surface of the mold wall facing the mold interior, which constitutes a contact area with the container blank. FIG. 17 shows a photograph of a half-shell of the negative mold, with the sieve mold having been removed from the plastic carrier.

### Production of the Container Blank

The half-shells of the negative mold are assembled and a rubber tube is connected to the mold opening as inlet, such that pulp can be pumped through the mold opening into the mold interior. At first, 0.45 liter of the pulp is introduced through the mold opening into the mold interior. The flow rate of the pulp here does not exceed 200 mm/s. Once the feeding of this first portion of the pulp has been stopped, compressed air is injected into the mold interior at 6 bar. In this way, the water in the pulp is partly forced out of the mold interior through the mold wall and hence the pulp introduced is partly dewatered. Then a further 0.45 liter of the pulp is pumped into the mold interior as a further portion, again via the rubber hose through the mold opening. Here too, a maximum flow rate of 200 mm/s of the pulp is not exceeded. Again, the flow of the pulp is stopped and compressed air is injected into the mold interior at 6 bar in order to further dewater the pulp in the mold interior. The sum total of the fiber content and additive content of the mass obtained in the mold interior that has been deposited on the mold wall is now 25% by weight. The water content is 75% by weight. This mass forms the blank wall of the container blank. It has an average density of 0.2 g/cm³. The container blank is demolded by separating the two half-shells of the negative mold of the container blank from one another.

### Negative Mold of the Container Precursor

A negative mold of the container precursor to be produced is provided. The negative mold of the container precursor consists of half-shells each consisting a porous aluminum (available as AlSi₇Mg from Exxentis). Channels for removal of water have been introduced into the aluminum. The channels have a diameter of 0.3 mm. In addition, the mold has a mold opening through which the hollow body below can be introduced into the blank interior when the container blank is in the mold interior. In addition, the shaping tool described below may grip onto the mouth region of the container blank present in the mold via the mold opening.

### Shaping Tool

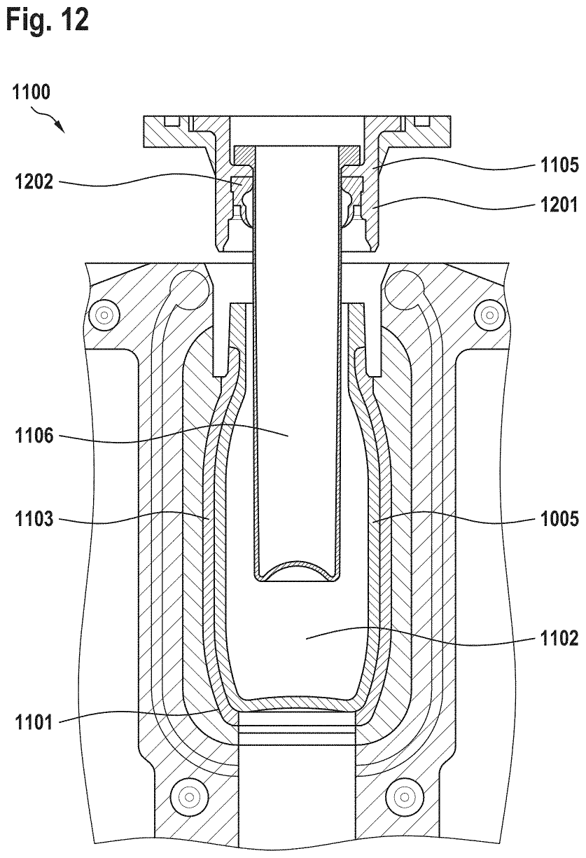

In addition, a shaping tool is provided, which is designed to form the mouth region of the container precursor (see FIGS. 12 to 16). For this purpose, the shaping tool has an outer ring made of aluminum that concentrically surrounds an inner ring made of silicone. The blank wall of the container blank may be accommodated between the two circular rings in the mouth region of the container blank that forms the blank opening with the edge foremost and hence compressed. In addition, the shaping tool comprises a hollow body disposed within the inner ring with an elastically deformable wall made of rubber. The hollow body has been provided with a feed through which compressed air can be injected into the hollow body at a few bar.

### Production of the Container Precursor

Firstly, the negative mold of the container precursor is preheated to 170° C. by means of an electrical heater. Then the container blank produced as described above is introduced into the negative mold of the container precursor and the half-shells of the mold are assembled. After the mold has been closed, the shaping tool is placed onto the mold as shown in FIGS. 12 to 16. The shaping tool here is pressed onto the container blank with a pressure of 25 N/mm². As a result, the container blank is pressed heightwise and hence reduced to 97% of the original height of the container blank. In addition, the edge of the mouth region of the blank wall is accommodated between the inner ring and the outer ring such that the blank wall is surrounded by the shaping tool at its edge. As a result, the edge is pressed and hence a relatively smooth surface without protruding fibers is obtained. The hollow body introduced into the blank interior as shown in FIGS. 12 to 16 is inflated with compressed air at 3 bar in order thus to press against the blank wall with a pressure of 0.4 N/mm² from the inside for 90 seconds. The elastically deformable hollow body made of rubber also presses against the inner ring made of silicone and hence forms smooth transitions of the mouth region of the blank wall. At the same time, a reduced pressure of 0.8 bar is applied to the outside of the mold wall of the negative mold of the container precursor. The sum total of fiber content and additive content of the container layer that forms the container precursor wall of the container precursor now formed is 93% by weight, and the moisture content of the container layer is 7% by weight. The average density of the container layer is 0.75 g/cm³.

### Coating

The coating is effected at an ambient temperature of 23° C., an ambient air pressure of 100 kPa (0.986 atm) and a relative air humidity of 50%, such that the moisture content of the container obtained as described above remains constant at 7% by weight. The container precursor is transferred to a powder coating system of the Encore HD type from Nordson, Erkrath, Germany. This system includes a holding device with an electrically conductive shaped body that accommodates and hence retains the container precursor. The shaped body is grounded and mounted so as to be rotatable about an axis. The holding device also includes a drive unit that can rotate the shaped body at 1500 revolutions per minute. The shaped body here is preferably in the form of a cup for receiving the container precursor, such that the shaped body partly surrounds the container precursor. The container precursor wall of the container precursor accommodated in the shaped body is contacted here with the grounded shaped body over 70% of its surface area remote from the container precursor interior. In addition, the powder coating system includes a spray lance that releases an LDPE powder. This lance has a multitude of nozzles. The LDPE powder is negatively electrically charged by applying a voltage of 25 kV at the lance tip and atomized both horizontally and vertically through the nozzles. The lance is introduced into the container precursor interior here at a speed of 15 m/min to an extent of 90% of the height of the container precursor interior. Once the LDPE powder has been sprayed onto the inside of the container layer and the edge surrounding the container precursor opening, the container precursor is heated to 185° C. in an oven for 10 min. This forms a continuous inner polymer layer from the powder coating that superimposes the container layer on its inside completely, i.e. to an extent of 100%, with a layer thickness of 40 μm. The container thus obtained is then transferred again into the holding device and secured on a conical spike rather than the cup-shaped body. The lance is then used to spray further LDPE powder at an electrical voltage of 25 kV from the outside onto the mouth region of the container, including the edge surrounding the container opening. Subsequently, container is heated to 185° C. in the oven again for 10 min. The powder coating thus applied gives rise here to a continuous outer polymer layer that superimposes the mouth region of the container on the outside with a layer thickness of 40 μm to an extent of 15% of the outside.

### Filling and Closing

The container produced as described above is sterilized and filled with a yoghurt in an Ermifill 24L filling machine from Ermi, France. Thereafter, a pull tab made of aluminum is sealed onto the edge surrounding the container opening by heat-sealing using the polymer layers applied as sealant and hence the container is closed.

The figures respectively show, in schematic form and not to scale, unless stated otherwise in the description or the respective figure:

FIG. 1 a schematic diagram of a container of the invention;

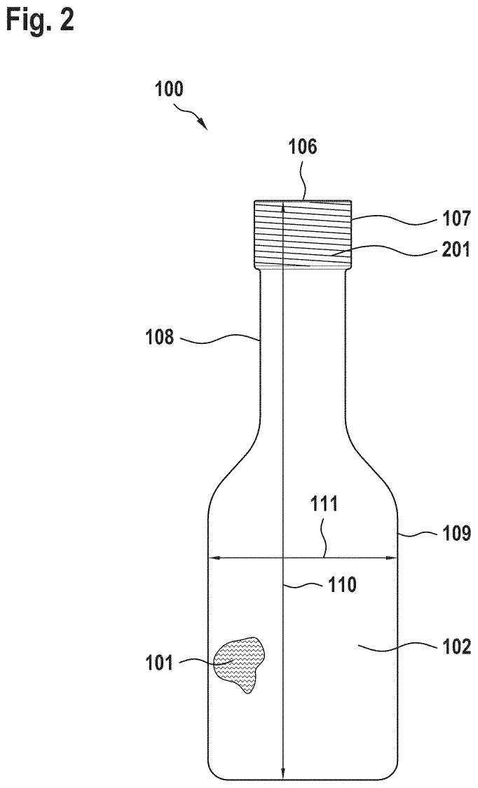

FIG. 2 a schematic diagram of a further container of the invention;

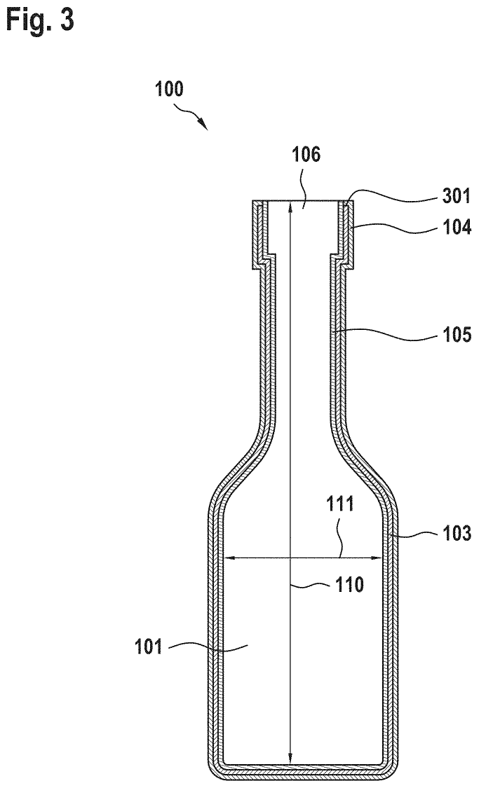

FIG. 3 a schematic cross-sectional diagram of the container of the invention from FIG. 2;

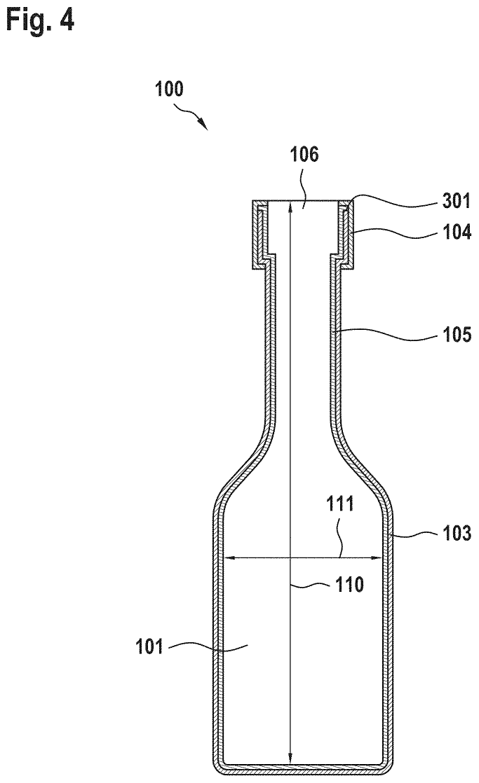

FIG. 4 a schematic cross-sectional diagram of a further container of the invention;

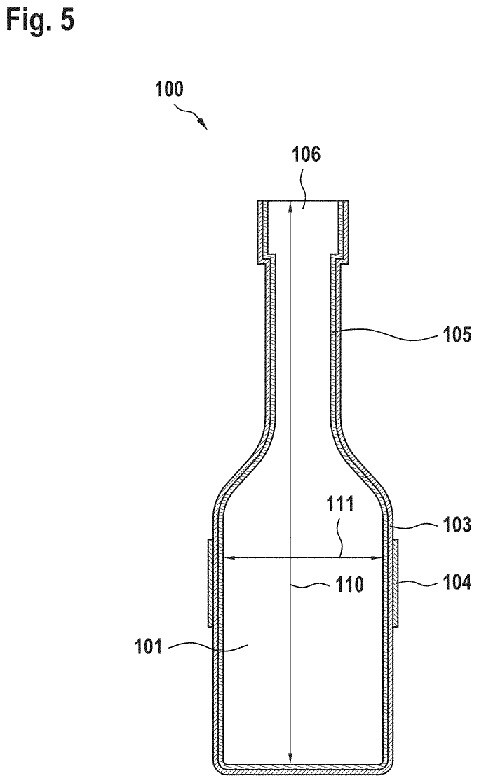

FIG. 5 a schematic cross-sectional diagram of a further container of the invention;

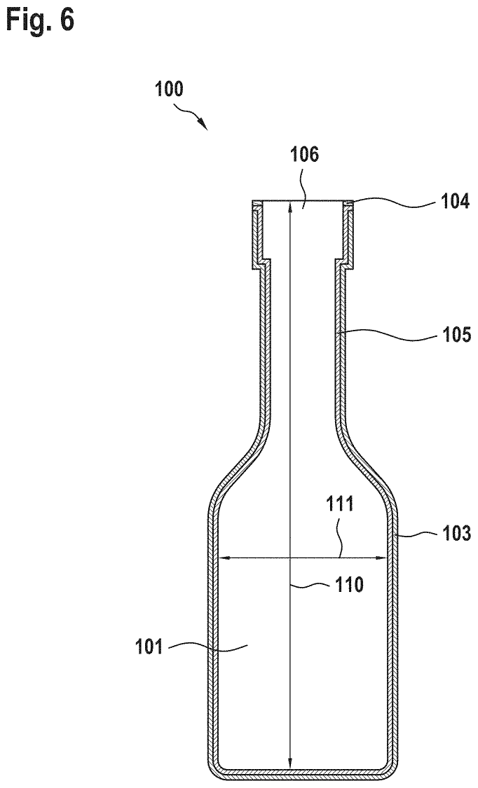

FIG. 6 a schematic cross-sectional diagram of a further container of the invention;

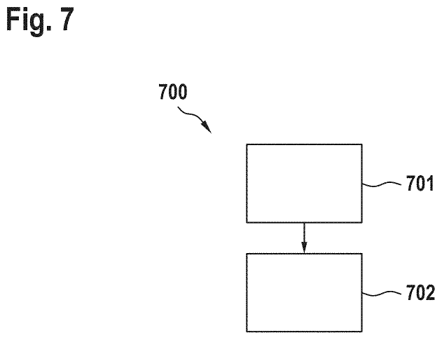

FIG. 7 a flow diagram of a method of the invention for producing a container;

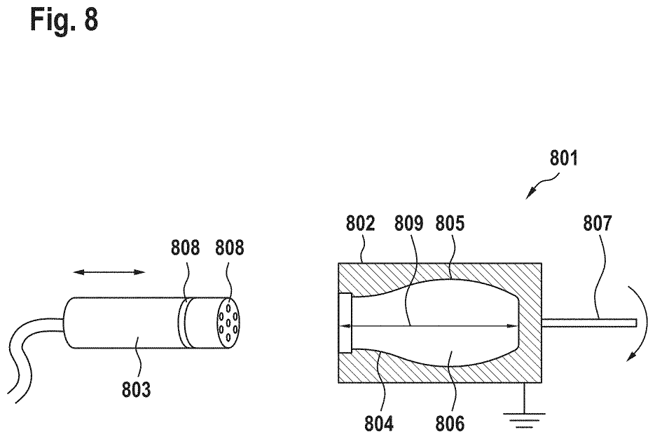

FIG. 8 a schematic diagram of an apparatus of the invention;

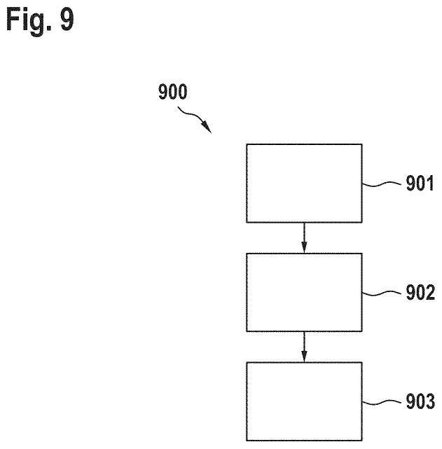

FIG. 9 a flow diagram of a method of the invention for filling and closing a container;

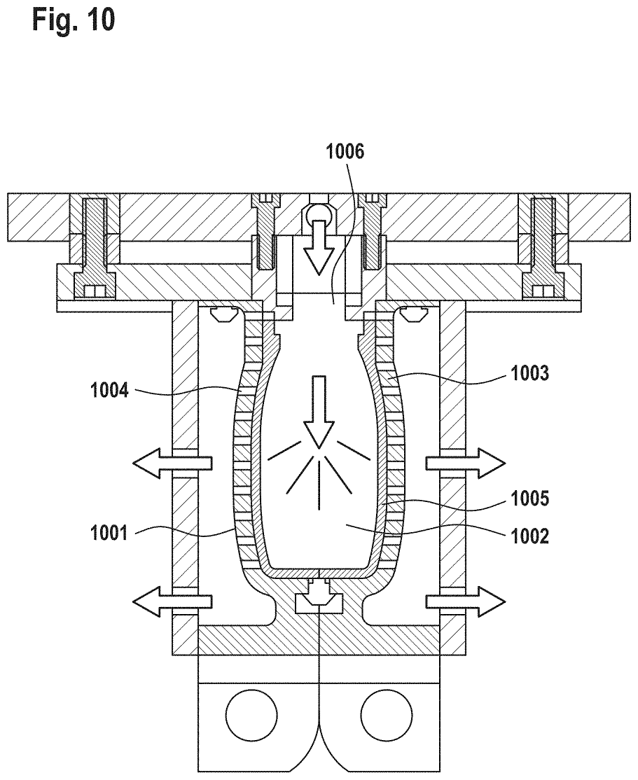

FIG. 10 a scheme for production of a container blank;

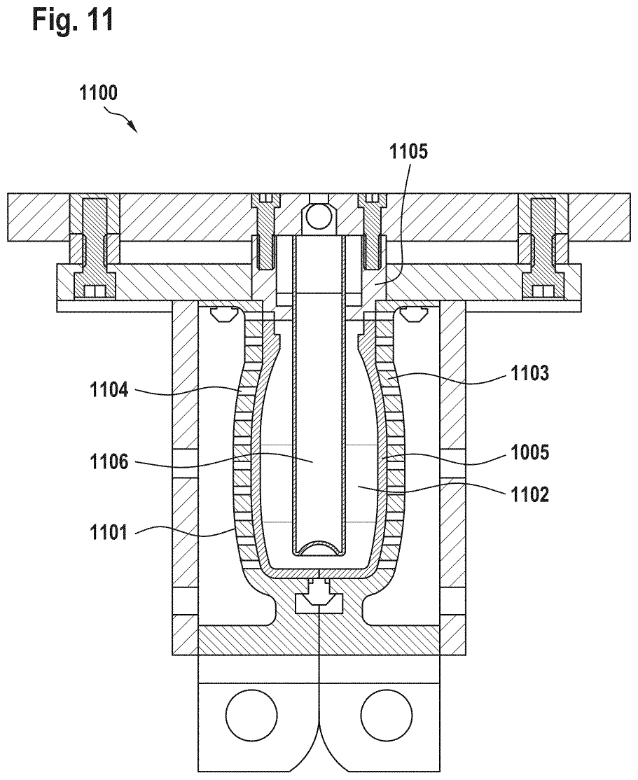

FIG. 11 a scheme for production of a container precursor;

FIG. 12 a further scheme for production of the container precursor;

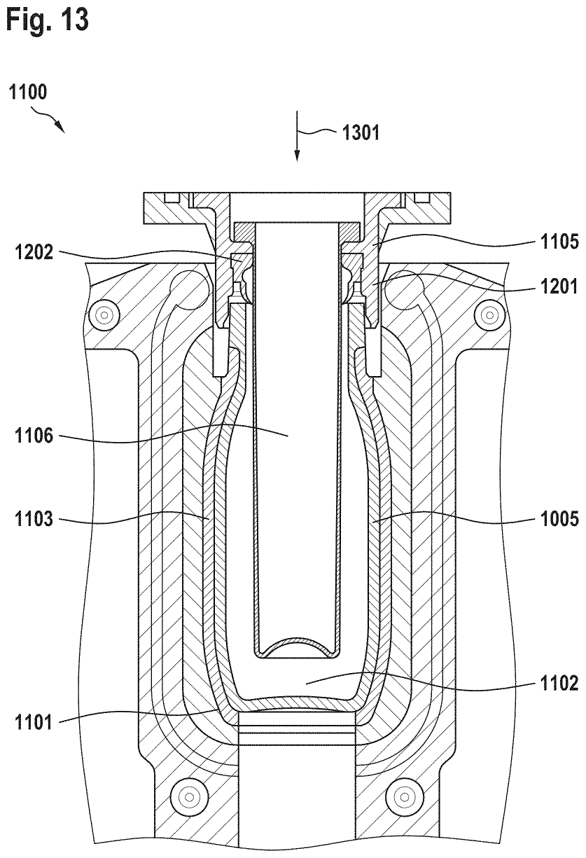

FIG. 13 a further scheme for production of the container precursor;

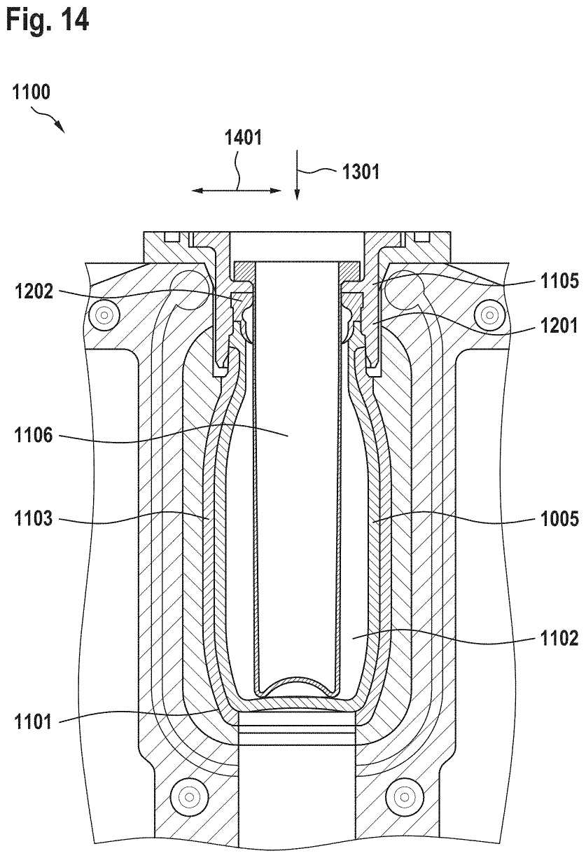

FIG. 14 a further scheme for production of the container precursor;

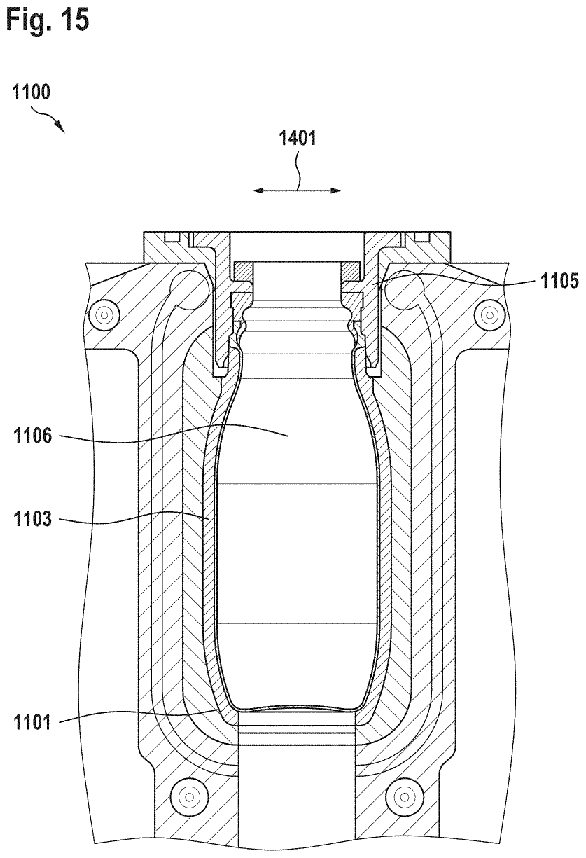

FIG. 15 a further scheme for production of the container precursor;

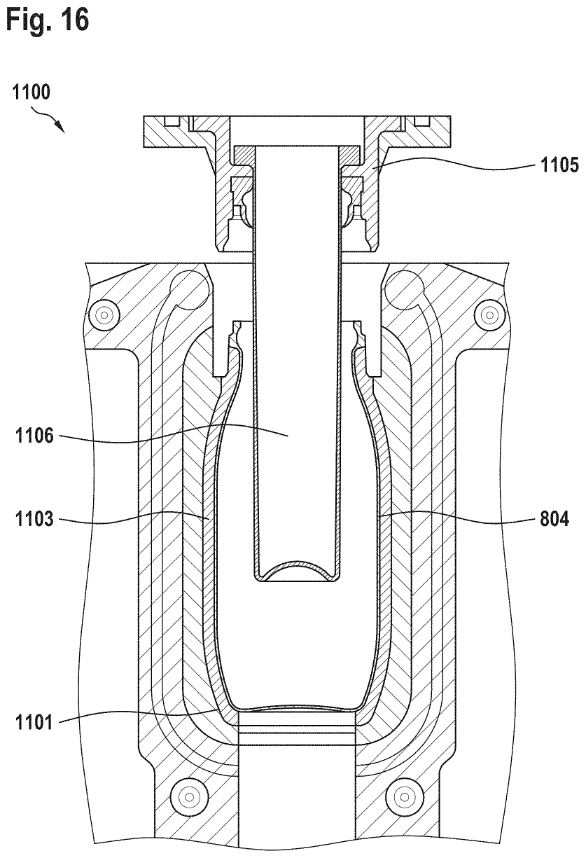

FIG. 16 a further scheme for production of the container precursor; and

FIG. 17 a photograph of a half-shell of the negative mold of the container blank in FIG. 10.

FIG. 1 shows a schematic diagram of a container 100 of the invention. The container 100 comprises a container wall 102 that at least partly surrounds a container interior 101. The container wall 102, as indicated in the encircled detail diagram, consists of a sequence of the following layers in superposed succession in the direction from the container interior 101 outward: an inner polymer layer 105 of PLA, a container layer 103, and an outer polymer layer 104 of polyethylene. The outer polymer layer 105 here is the first polymer layer of the invention. According to the invention, the inner polymer layer 105 is the further polymer layer. The outer polymer layer 104 and the inner polymer layer 105 are each fully coated onto the container layer 103. Thus, the outer polymer layer 104 completely covers the container layer 103 on its side remote from the container interior 101. In addition, the inner polymer layer 105 completely covers the container layer 103 on its side facing the container interior 101. The container 100 is a bottle having a container opening 106 in a mouth region 107. The mouth region 107 is connected to a bottle body 109 via a bottle neck 108. The container layer 103 consists to an extent of 92.9% by weight, based on the total weight of the container layer 103, of fibers obtained from spruce wood as ground wood with an average fiber length of 1.5 mm. In addition, the container layer 103 has a moisture content of 7% by weight, based on the total weight of the container layer 103, and includes 0.1% by weight of additives, for example AKD and ASA, as hydrophobizing agents. The container layer 103 does not include any fold or seam at all. The container 100 includes the outer polymer layer 104 in a proportion of 5% by weight, based on the total weight of the container 100. The inner polymer layer 105 is included in the container 100 in a proportion of 15% by weight, based on the total weight of the container 100. The container interior 101 has a maximum diameter 111 in a plane perpendicular to a height 110 of the container interior 101, where the container interior 101 has a diameter less than the maximum diameter 111 of the container interior 101 throughout in the direction from the plane to the container opening 106. This is illustrated in the dotted guidelines included in FIG. 1.

FIG. 2 shows a schematic diagram of a further container 100 of the invention. This container 100 also takes the form of a bottle. The bottle again comprises a container wall 102 that at least partly surrounds a container interior 101. The container wall 102 consists of a sequence of the following layers in superposed succession in the direction from the container interior 101 outward: an inner polymer layer 105 of EVOH, a container layer 103, and an outer polymer layer 104 of PET. The bottle has a container opening 106 in a mouth region 107. In addition, the mouth region 107 has been provided with a screw thread 201 for screwing on a lid as closure. The screw thread 201 has been formed here by the container layer 103 and coated with the outer polymer layer 104. The mouth region 107 is connected to a bottle body 109 via a bottle neck 108. The container layer 103 consists to an extent of 92.9% by weight, based on the total weight of the container layer 103, of fibers obtained from spruce wood as ground wood with an average fiber length of 1.5 mm. In addition, the container layer 103 has a moisture content of 7% by weight, based on the total weight of the container layer 103, and includes 0.1% by weight of additives, for example AKD and ASA, as hydrophobizing agents, and Eka ATC 4150 from Eka Chemicals as flow agent. The container layer 103 has an average thickness of 650 μm and is no thinner than 300 μm at any point in the container wall 102. In addition, the container layer 103 does not include any fold or crease at all. The inner polymer layer 105 has an average layer thickness of 80 μm. The outer polymer layer 104 has an average layer thickness of 50 μm. The container interior 101 has a maximum diameter 111 in a plane perpendicular to a height 110 of the container interior 101, where the container interior 1017 has a diameter less than the maximum diameter 111 of the container interior 101 in the direction from the plane to the container opening 106, i.e. in the region of the bottle neck 108 and the mouth region 107.

FIG. 3 shows a schematic cross-sectional diagram of the container 100 of the invention from FIG. 2. It can be seen in FIG. 3 that the outer polymer layer 104 and the inner polymer layer 105 have each been coated over the full area of the container layer 103. In this case, the edge 301 of the container layer 103 which is at the top in FIG. 3 and runs around the container opening 106 has been coated with the outer polymer layer 104 but not with the inner polymer layer 105. Since this edge 301 for the use herein is not regarded either as facing or as being remote from the container interior 101, the inner polymer layer 105 is considered to have been fully coated.

FIG. 4 shows a schematic cross-sectional diagram of a further container 100 of the invention. The container 100 in FIG. 4 has the design of the container 100 in FIG. 2. In a departure from the container 100 in FIG. 2, the outer polymer layer 104 here does not superimpose the container layer 103 completely, but only over about 20% of the surface area of the container layer 103 remote from the container interior 101. The container layer 103 here has especially been coated with the outer polymer layer 104 over the entire mouth region 107 of the container 100.

FIG. 5 shows a schematic cross-sectional diagram of a further container 100 of the invention. The container 100 in FIG. 5 has the design of the container 100 in FIG. 2. In a departure from the container 100 in FIG. 2, the outer polymer layer 104 here does not superimpose the container layer 103 completely, but only over about 30% of the surface area of the container layer 103 remote from the container interior 101. The container layer 103 here has been partly coated with the outer polymer layer 104 only in the region of the bottle body 109. Such an outer polymer layer 104 is especially suitable for printing with information as to the container contents and promotional information.

FIG. 6 shows a schematic cross-sectional diagram of a further container 100 of the invention. The container 100 in FIG. 6 has the design of the container 100 in FIG. 4. In a departure from the container 100 in FIG. 4, the outer polymer layer 104 here does not superimpose the container layer 103 completely. The container layer 103 here has been coated with the outer polymer layer 104 in the mouth region 107 only on its edge 301 that surrounds the container opening 106. Such an outer polymer layer 104 is particularly suitable as sealant for sealing of a film that covers the container opening 106 as a closure for the container 100. In addition, a lid may be screwed onto the container 100 as a further part of the closure.

FIG. 7 shows a flow diagram of a method 700 of the invention for producing a container 100.

The method 700 includes a method step a) 701: producing a container precursor 804. A container precursor wall 805 consisting of a container layer 103 is produced here from a composition comprising water to an extent of 99% by weight, a multitude of fibers to an extent of about 1% by weight, and additives such as hydrophobizing agents and flow agents to an extent of less than 0.02% by weight, based in each case on the total weight of the composition. The fibers are ground wood having an average fiber length of 1.5 mm. The composition is also called pulp. The composition is introduced into a negative mold 1001 of a container blank 1005 in order to obtain the container blank 1005. Details of the production of the container blank 1005 are elucidated in connection with FIG. 10. This container blank 1005 is hot-pressed in a hot pressing device 1100 with a negative mold 1101 of the container precursor 804 in order to obtain a container precursor 804. Details of the hot pressing are described for FIGS. 11 to 16. In the hot pressing, the container layer 103 is dried only to such an extent that it does not go below a minimum moisture content of 5% by weight, based on the weight of the container layer 103. The container precursor 804 thus obtained is not dried further, and so the moisture content does not go below the aforementioned minimum moisture content at any time. The container precursor wall 805 surrounds a container precursor interior 806, except for a container precursor opening. In a method step b) 702 of the method 700, the container layer 103 is coated with a first polymer composition on its side remote from the container interior 806. The container layer 103 here has a moisture content of 7% by weight. The coating with the first polymer composition is effected as a powder coating operation.

FIG. 8 shows a schematic diagram of an apparatus 800 according to the invention. This comprises a holding device 801 comprising a shaped body 802 arranged and designed so as to hold a container precursor 804. The container precursor 804 comprises a container precursor wall 805 that at least partly surrounds a container precursor interior 806. The container precursor wall 805 consists of a container layer 103 and has a container precursor opening 810. The container layer 103 consists to an extent of 92.5% by weight, based on the total weight of the container layer 103, of fibers in the form of ground wood. The container precursor interior 806 has a maximum diameter in a plane perpendicular to a height of the container precursor interior, and a diameter less than the maximum diameter of the container precursor interior 806 at least in sections in the direction from the plane to the container precursor opening 810. The shaped body 802 consists of a metal and is composed of half-shells. In addition, the shaped body 802 is grounded and mounted so as to be rotatable about an axis 807. The holding device 801 also includes a drive unit (not shown) arranged and set up to rotate the shaped body 802 about the axis 807 at 1500 revolutions per minute. The shaped body 802 is configured in the form of a cup for receiving the container precursor 804, such that the shaped body 802 partly surrounds the container precursor 804. The container precursor wall 805 of the container precursor 804 accommodated in the shaped body 802 as shown is contacted here with the grounded shaped body 802 over 100% of its surface area remote from the container precursor interior 806. The apparatus 800 further includes a release device 803 arranged and designed so as to release a polymer composition in such a way that the container layer 103 is at least partly superimposed by the polymer composition. The release device 803 is designed here as a spray lance with a multitude of nozzles 808. Multiple nozzles 808 here are arranged on an end face of the lance, and a slot-shaped nozzles 808 that runs around a shell surface of the lance on the shell surface. This lance is designed to atomize a powder composed of a multitude of electrically charged polymer particles via the nozzles 808 in order to obtain a very homogeneous cloud of powder. The lance is arranged and designed so as to be movable relative to the shaped body 802, such that the lance can be introduced at least partly into the container precursor interior 106 of the container precursor 804 held by the shaped body 802. The lance here is arranged and designed so as to be movable in a direction in which the container precursor interior 806 has a dimension 809. The lance is arranged and designed so as to be movable such that it can be introduced into the container precursor interior 806 to an extent of 90% of the dimension 809. In addition, the holding device 801 and the release device 803 are arranged and designed to coat the container layer 103 completely on its surface facing the container precursor interior 806 with the polymer composition. In addition, the apparatus 800 includes a charging device (not shown) arranged and designed for electrically negatively charging the powder as polymer composition by applying a high voltage to the end face of the lance. In this way, the powder can be electrically charged relative to the grounded shaped body 802. The apparatus 800 is designed for powder coating of the container precursor 804 with the polymer composition on its surface facing the container precursor interior 806.

FIG. 9 shows a flow diagram of a method 900 of the invention for filling and closing a container 100. In a method step I) 901, the container 100 of FIG. 6 is provided. The subsequent method steps II) 902 and III) 903 are conducted in a filling machine. In method step II) 902, the container 100 is filled with a smoothie through its opening 106. In method step III) 903, the container thus filled is closed. For this purpose, an aluminum foil is sealed over the container opening 106 by heat-sealing using the outer polymer layer 104 and the inner polymer layer 105 as sealant.

FIG. 10 shows a scheme for production of a container blank 1005. First of all, a composition that is composed as specified for FIG. 7 is provided. The composition is also referred to as pulp. In addition, a negative mold 1001 of the container blank 1005 is provided. The negative mold 1001 includes a mold wall 1003 partly surrounding a mold interior 1002. The mold wall 1003 partly surrounds the mold interior 1002 here in that the negative mold 1001 includes a mold opening 1006 that connects the mold interior 1002 to an environment of the negative mold 1001. The mold interior 1002 has a maximum diameter in a plane perpendicular to a height of the mold interior 1002, with the mold interior 1002 having a diameter less than the maximum diameter of the mold interior 1002 throughout in the direction from the plane to the mold opening 1006, meaning that the mold interior 1002 narrows from the plane of the maximum diameter toward the mold opening 1006. The mold wall 1003 has a multitude of openings 1004. The size of the openings 1004 has been chosen such that the mold wall 1003 is permeable to the water from the pulp, but not the fibers from the pulp that have an average fiber length of 1.5 mm. The construction of the mold wall 1003 is described in detail in connection with FIG. 17. For production of the container blank 1005, a first portion of the composition is introduced into the negative mold 1001. For this purpose, the first portion of the pulp flows through the mold opening 1006 into the mold interior 1002. Concurrently therewith, the pulp flowing in meets the inside of the mold wall 1003, and the water from the first portion partly passes through the openings 1004 and hence is removed again from the first mold interior 1002. This is supported by a reduced pressure applied to the mold wall 1003 from the outside. In this regard, the arrows in FIG. 10 show the flow of the water. In the aforementioned process steps, the first portion does not have a flow rate of more than 200 mm/s at any point in the mold interior 1002. While the water from the first portion of the pulp partly leaves the mold interior 1002 again, the fibers from the first portion cannot pass through the mold wall 1003 through the openings 1004. As a result, the fibers are deposited on the side of the mold wall 1003 facing the mold interior 1002. In order to further dewater the deposited and partly dewatered pulp, compressed air is introduced into the mold interior 1002, such that the pressure in the mold interior 1002 is increased and the fibers with the remaining water are pressed against the mold wall 1003 from the inside and hence a further proportion of the water is pressed out of the mold interior 1002. Once the compressed air has been released again, a further portion of the pulp flows into the mold interior 1002. Analogously to the above process steps, the pulp from the further portion flowing in meets the inside of the partly dewatered pulp from the first portion that has been deposited on the mold wall 1003. A portion of the water from the further portion flows here through the partly dewatered pulp from the first portion and through the openings 1004, as a result of which part of the water is removed again from the mold interior 1002. This is again supported by the reduced pressure applied to the mold wall 1003 from the outside. The further portion here does not have a flow rate of more than 200 mm/s at any point in the mold interior 1002. In order to further dewater the deposited and partly dewatered pulp from the first and further portions, compressed air is again introduced into the mold interior 1002, such that the pressure in the mold interior 1002 is increased once more and the fibers from the first and further portions with the remaining water are pressed against the mold wall 1003 from the inside and hence a further proportion of the water is pressed out of the mold interior 1002. Since the negative mold 1001 is designed as a negative mold of the container blank 1005, the latter is obtained as a result. The container blank 1005 consists of the partly dewatered pulp and already has the shape of a bottle. Consequently, the container blank 1005 has a blank wall that partly surrounds a blank interior. The blank wall has an average density of 0.2 g/cm³. The blank wall has a blank opening, where the blank interior has a maximum diameter in a plane perpendicular to a height of the blank interior, where the blank interior has a diameter less than the maximum diameter of the blank interior throughout in the direction from the plane to the blank opening. The height of the blank interior here is a greatest dimension of the blank interior in any Cartesian spatial direction and extends from the blank opening to a section of the blank wall opposite the blank opening that is a base of the container blank. The region of the blank wall that forms the blank opening is referred to as mouth region. Thereafter, the negative mold 1001 consisting of half-shells is opened in order to demold the container blank 1005 obtained.

FIG. 11 shows a scheme for production of a container precursor 804 by hot pressing in a hot pressing device 1100 from the above container blank 1005. For this purpose, the container blank 1005 is introduced into a negative mold 1101 of the container precursor 804 as part of the hot pressing device 1100. For this purpose, the negative mold 1101 has been constructed from half-shells. The negative mold 1101 includes a mold wall 1103 partly surrounding a mold interior 1102. The mold wall 1103 is in porous form and accordingly has a multitude of openings 1104, where the openings 1104 are pores. The size of the pores has been chosen such that the mold wall 1103 is permeable to the water present in the blank wall, but not to the fibers. In addition, the hot pressing device includes a shaping tool 1105 comprising a hollow body 1106. This hollow body 1106 has an elastically deformable wall. Shaping of the container blank 1005 in the mold interior 1102 of the negative mold 1101 gives the container precursor 804 from the container blank 1005. The container precursor 804 comprises a container precursor wall 805 that partly surrounds a container precursor interior 806. This consists here of a container layer 103 which is obtained from the blank wall. The container layer 103 has an average density of 0.75 g/cm³. Details of the hot pressing in the hot pressing apparatus are shown in FIGS. 12 to 16 and elucidated with regard thereto. FIGS. 12 to 16 should be viewed here in a time sequence.

FIG. 12 shows a further scheme for production of the container precursor 804. This shows a section through the heating device 1100 with the negative mold 1101 of the container precursor 804 and the shaping tool 1105 with the hollow body 1106. The container blank 1005 to be pressed is in the mold interior 1102. The shaping tool 1105 comprises a circular outer ring 1201 made of aluminum and a circular inner ring 1202 made of silicone. The inner ring 1202 is concentrically within the outer ring 1201 and arranged so as to be elastically deformable with respect thereto.

FIG. 13 shows a further scheme for production of the container precursor 804. By comparison with FIG. 12, this shows that the shaping tool 1105 with the hollow body 1106 is moved in a first direction 1301. As a result, the hollow body 1106 is introduced further into the blank interior. In addition, the shaping tool 1105 is in contact with the container blank 1005 in its mouth region. The contacting of the mouth region with the shaping tool 1105 includes accommodating of the blank wall in the mouth region 1202 between the outer ring 1201 and the inner ring 1202 of the shaping tool 1105.

FIG. 14 shows a further scheme for production of the container precursor 804. By comparison with FIG. 13, the shaping tool 1105 has been moved here further in the first direction 1301, such that the shaping tool 1105 grips the negative mold 1101 which is closed. By virtue of this movement, the shaping tool 1105 grips the mouth region of the container blank 1005 such that it presses the blank wall in the first direction 1301 along a length of the container precursor 1005. This reduces the height of the container blank 1005. At the same time, the shaping tool 1105 grips the mouth region of the container blank 1005 such that the blank wall in the mouth region is pressed in a further direction 1401. The further direction 1401 is arranged radially here, i.e. in a plane perpendicular to the height of the container blank 1005. In FIG. 14, the mouth region of the container blank 1005 has already been pressed between the outer ring 1201 and the inner ring 1202 and hence obtained by shaping of the mouth region of the container precursor 804. It can also be seen that the outer ring 1201 surrounds the blank wall in the mouth region of the container blank 1005 along an outer circumference of the mouth region. In addition, the inner ring 1202 engages with the blank interior and contacts the blank wall in the mouth region of the container blank 1005 along an inner circumference of the mouth region of the container blank 1005.

FIG. 15 shows a further scheme for production of the container precursor 804. By comparison with FIG. 14, oil at 180° C. was introduced here into the hollow body 1106, such that the elastically deformable wall thereof has been deformed to such a degree that it presses the blank wall against the mold wall 1101 from the inside. This affords the container layer 103 that forms the container precursor wall 805, and hence the container precursor 804. The above-described to hot pressing gives the container layer 103 its minimum moisture content of 5% by weight.

FIG. 16 shows a further scheme for production of the container precursor 804. Here, proceeding from FIG. 15, the oil was sucked back out of the hollow body 1106 and the latter is removed from the mold interior 1102, such that the container precursor 804 can be demolded from the negative mold 1101 by opening the half-shells.

FIG. 17 shows a photograph of a half-shell 1700 of the negative mold 1001 of the container blank 1005 in FIG. 10. The half-shell 1700 consists of a plastic carrier 1701 with a multitude of holes. A sieve mold 1702 is to be inserted into this plastic carrier 1701. The sieve mold 1702 forms the surface of the mold wall 1003 on which the fibers of the pulp are deposited in the production of the container blank 1005.

### LIST OF REFERENCE NUMERALS

100 container of the invention
101 container interior
102 container wall
103 container layer
104 outer polymer layer
105 inner polymer layer
106 container opening
107 mouth region
108 bottle neck
109 bottle body
110 height of the container interior
111 maximum diameter of the container interior
201 screw thread
301 edge
700 method of the invention for producing a container
701 method step a)
702 method step b)
800 apparatus of the invention
801 holding device
802 shaped body
803 release device
804 container precursor
805 container precursor wall
806 container precursor interior
807 axis
808 nozzle
809 dimension
810 container precursor opening
900 method of the invention for filling and closing a container
901 method step I)
902 method step II)
903 method step III)
1001 negative mold of the container blank
1002 mold interior of the negative mold of the container blank
1003 mold wall of the negative mold of the container blank
1004 opening of a multitude of openings in the mold wall of the negative mold of the container blank
1005 container blank
1006 mold opening of the negative mold of the container blank
1100 hot pressing device
1101 negative mold of the container precursor
1102 mold interior of the negative mold of the container precursor
1103 mold wall of the negative mold of the container precursor
1104 opening of a multitude of openings in the mold wall of the negative mold of the container precursor
1105 shaping-tool
1106 hollow body
1201 outer ring
1202 inner ring
1301 first direction
1401 further direction
1700 half-shell of the negative mold of the container blank
1701 plastic carrier
1702 sieve mold

1. A container comprising a container wall that partly surrounds a container interior, wherein the container wall
a) has a container opening;
b) comprises a container layer comprising
i) a multitude of particles, and
ii) no fold and no crease;
and
c) comprises a first polymer layer that at least partly superimposes the container layer;
wherein the container interior
a. has a maximum diameter in a plane perpendicular to a height of the container interior, and
b. has a diameter less than the maximum diameter of the container interior at least in sections in the direction from the plane to the container opening.

2. The container as claimed in claim 1, wherein the particles of the multitude of particles are fibers.

3. The container as claimed in claim 2, wherein the fibers comprise a chemical pulp or a mechanical pulp or both.

4. The container as claimed in claim 1, wherein the container layer comprises solids in a proportion within a range from 50% to 99.9% by weight, based on the weight of the container layer.

5. The container as claimed in claim 1, wherein the first polymer layer at least partly superimposes the container layer on a side remote from the container interior.

6. The container as claimed in claim 1, wherein the first polymer layer at least partly superimposes the container layer on a side facing the container interior.

7. A method comprising, as method steps,
a) providing a container precursor comprising a container precursor wall partly surrounding a container precursor interior, wherein the container precursor wall
I. has a container precursor opening, and
II. comprises a container layer comprising a multitude of particles,
wherein the container precursor interior
i. has a maximum diameter in a plane perpendicular to a height of the container precursor interior, and
ii. has a diameter less than the maximum diameter of the container precursor interior at least in sections in the direction from the plane to the container precursor opening; and
b) at least partly superimposing the container layer with a first polymer composition.

8. The method as claimed in claim 7, wherein the container layer does not comprise any fold or any crease.

9. The method as claimed in claim 7, wherein the container precursor is provided in process step a) with a minimal first moisture content of the container layer,
wherein the container layer in method step b) has a further moisture content,
wherein the minimal first moisture content differs from the further moisture content by not more than 10% by weight, wherein each of the moisture contents are based on the weight of the container layer.

10. The method as claimed in claim 7, wherein the providing of the container precursor in method step a) comprises producing the container layer from a composition,
wherein the composition comprises
a. the multitude of particles, and
b. a liquid.

11. The method as claimed in claim 7, wherein the container layer in method step b) is superimposed with the first polymer composition at least on a side facing the container precursor interior.

12. The method as claimed in claim 7, wherein the container layer in method step b) is superimposed with the first polymer composition at least on a side remote from the container precursor interior.

13. The method as claimed in claim 7, wherein the first polymer composition comprises a first multitude of polymer particles.

14. The method as claimed in claim 7, wherein the container layer in method step b) has a moisture content within a range from 0% to 20% by weight, based on the weight of the container layer.

15. The method as claimed in claim 7, wherein the first polymer composition in method step b) has been electrically charged with respect to the container precursor wall.
